(19) United States
(12) Patent Application Publication
(10) Pub. No.: US 2020/0082188 A1
(43) Pub. Date: Mar. 12, 2020

(54) METHODS AND SYSTEMS FOR REAL-TIME MONITORING OF VEHICLES

(71) Applicant: GAUSS MOTO, INC., Milpitas, CA (US)

(72) Inventor: Vineet Kumar SINGH, Milpitas, CA (US)

(73) Assignee: GAUSS MOTO, INC., Milpitas, CA (US)

(21) Appl. No.: 16/561,687

(22) Filed: Sep. 5, 2019

Related U.S. Application Data
(60) Provisional application No. 62/728,482, filed on Sep. 7, 2018.

(51) Int. Cl. G06K 9/00; G08B 25/10; G06N 20/00

(52) U.S. Cl. CPC G06K 9/00832; G08B 25/10; G06K 2009/00738; G06K 9/00791; G06N 20/00; G06K 9/00711

(57) ABSTRACT

Embodiments disclosed herein relate to surveillance systems and more particularly providing an Artificial Intelligence (AI) assisted security surveillance device in vehicles. Embodiments herein provide real-time monitoring of vehicle and surrounding environment of the vehicle including, but not limited to, gestures, voice, behaviors of both drivers and passengers, and so on. Embodiments herein provide real-time alerts to at least one external entity on identifying an emergency situation.

### CROSS REFERENCE TO RELATED APPLICATION

This application is based on and derives the benefit of U.S. Provisional Application 62/728,482, filed on Sep. 7, 2018, the contents of which are incorporated herein by reference.

### TECHNICAL FIELD

The embodiments herein relate to surveillance systems and, more particularly, to providing an Artificial Intelligence (AI) assisted surveillance device for monitoring vehicles in real-time.

### BACKGROUND

With increased adoption of ride hailing and ride sharing services, safety of passengers/commuters and drivers has become a major concern. The safety can be ensured by detecting at least one unusual activity related to a ride and alerting the detected unusual activity to a relevant person.

In conventional approaches, a surveillance system including cameras and alarm button can be deployed in a vehicle for ensuring the safety of the commuters/driver. The surveillance system may capture videos of the commuter(s) and driver present in the vehicle during the ride using the cameras. The surveillance system further enables the commuter/driver to use the alarm button on detecting any crime/threat/emergency situations. However, contents of the captured video can be analyzed later, since the surveillance system may not be connected to any other device for real-time analytics. Further, the alarm button may become useful only after the crime/threat has already been committed.

Thus, in the conventional approaches, there may be ambiguity in determining any crime/threat/emergency occurred during the ride due to lack of real-time analytics.

### BRIEF DESCRIPTION OF THE FIGURES

The embodiments disclosed herein will be better understood from the following detailed description with reference to the drawings, in which:

FIGS. 1a and 1b depict a security surveillance system, according to embodiments as disclosed herein;

FIG. 2 is a block diagram illustrating various hardware components of a security device, according to embodiments as disclosed herein;

FIG. 3a is a block diagram illustrating various hardware components of a server for detecting unusual activity during a ride, according to embodiments as disclosed herein;

FIG. 3b is a block diagram illustrating various hardware components of a security device for detecting the unusual activity during a ride, according to embodiments as disclosed herein;

FIG. 4 depicts an example security surveillance system, according to embodiments as disclosed herein;

FIGS. 5a and 5b depict example scenarios of a registration process for accessing at least one ride service, according to embodiments as disclosed herein;

FIG. 6a is an example flow diagram illustrating a method for initiating a ride process, according to embodiments as disclosed herein;

FIG. 6b is an example flow diagram illustrating a method for initializing the ride, according to embodiments as disclosed herein;

FIG. 7 is an example flow diagram illustrating a method for ride monitoring, according to embodiments as disclosed herein;

FIGS. 8a-8d depict an example security device, according to embodiments as disclosed herein;

FIGS. 9a, 9b, 9c, 9d, 9e, and 9f are example diagrams depicting placements of at least one of the security device, a camera, sensors in the vehicle, according to embodiments as disclosed herein;

FIGS. 10a-10h are example diagrams depicting the placements of the camera/sensors in the vehicle, according to embodiments as disclosed herein;

FIGS. 11a-11e depict example scenarios, wherein the security device is monitoring the interior of the vehicle, according to embodiments as disclosed herein;

FIGS. 12a, 12b, 12c, 12d and 12e depict media of the vehicle with real-time information, according to embodiments as disclosed herein;

FIG. 13 depicts an example scenario, wherein a user/third party is tracking the ride using a ride tracking application, according to embodiments as disclosed herein;

FIGS. 14a and 14b depict example UIs of the application, which enable users/third party to interact with external entities, according to embodiments as disclosed herein; and

FIG. 15 is a flow diagram illustrating a method for monitoring of the vehicle in real-time, according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Embodiments herein provide methods and systems for real-time monitoring of at least one vehicle (internal and external activities) during a ride by ensuring a safety of commuters/passengers and drivers.

Embodiments herein disclose methods and systems for detecting at least one unusual activity during the ride by analyzing data collected from various sensors present inside/outside the vehicle and leveraging at least one method such as, but not limited to, Artificial Intelligence (AI), machine learning techniques, and so on.

Embodiments herein disclose methods and systems for alerting at least one passenger/one or more third parties/law enforcement agencies on detecting the at least one unusual activity during the ride.

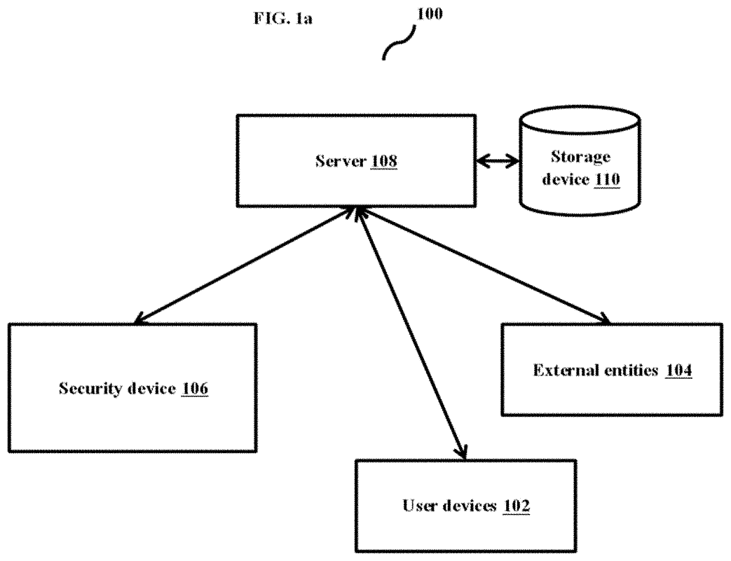

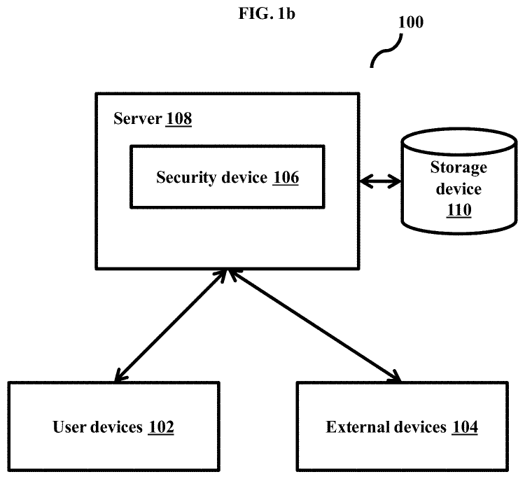

Referring now to the drawings, and more particularly to FIGS. 1a through 15, where similar reference characters denote corresponding features consistently throughout the figures, there are shown embodiments.

FIGS. 1a and 1b depict a security surveillance system 100, according to embodiments as disclosed herein. The security surveillance system 100 referred herein can be configured for real-time monitoring of at least one vehicle and surrounding of the vehicle, by ensuring safety of users during a ride/commute/trip. In an embodiment, the vehicle can be at least one of a private vehicle, a commercial vehicle, a public vehicle, and so on. In an embodiment, the vehicle can be at least one of an autonomous vehicle, a semi-autonomous vehicle, a manually operated vehicle having no self driving features, and so on. Examples of the vehicle can be, but not limited to, cars, buses, trucks, and so on. The users can include at least one of drivers and commuters. Embodiments herein use the terms such as “drivers”, ‘operators”, and so on interchangeably to refer to a person who drives/operates the at least one vehicle. Embodiments herein use the terms “commuters”, “passengers”, “customers”, “riders”, and so on interchangeably to refer to a person who uses the at least one vehicle to travel/commute/ride.

The security surveillance system 100 includes external entity(ies) 104, user device(s) 102, a security device 106, a server 108, and a storage device 110. The server 108 can communicate with the external entities 104, the user devices 102, and the security device 106 using a communication network. Examples of the communication network can be, but not limited to, the Internet, a wireless network (a Wi-Fi network, a cellular network, a Wi-Fi Hotspot, Bluetooth, Zigbee and or the like), a wired network, and so on.

The user device 102 can be a device used by the driver(s) and the commuter(s) to communicate with the server 108 and/or the security device 106. Examples of the user device 102 can be, but not limited, to a mobile phone, a smart phone, a tablet, a computer, a wearable computing device, an IoT (Internet of Things) device, a vehicle instrument console, a vehicle infotainment system, and so on.

The external entity 104 can be configured to receive at least one of monitored data of the vehicle and surrounding of the vehicle, events/activities identified inside/outside of the vehicle, emergency alerts, and so on from the server 108/security device 106. Examples of the external entity 104 can be, but is not limited to, a fleet monitoring center, a surveillance center, nearby vehicles, at least one emergency contact/one or more third parties, emergency services, law enforcement agencies and so on. Examples of the events can be, but not limited to, the commuter(s) entering the vehicle, activities of the driver and the commuter(s), interaction between the driver and the commuter(s), interaction between the co-passengers, conditions of objects (such as sensors, cameras, and so on) present in the vehicle, route updates, traffic updates, and so on. The emergency alerts can indicate at least one unusual activity/threat detected during the scheduled ride. The unusual activity can be at least one of a threat event, a crime event, an event that can lead to emergencies, an event indicating anomaly in the activities of the users and so on. Examples of the unusual events can be, but not limited to, the commuter has entered a wrong cab, the driver is intoxicated and/or drowsy, the driver or co-passenger/commuter misbehavior, the commuter or the driver refused to follow guidelines, presence of unauthorized commuter(s)/object(s) in the vehicle, damage caused to the vehicle ambience, obstructions to the camera(s)/sensor(s), tampered camera(s)/sensor(s), and so on. Embodiments herein use the terms “unusual activity”, “unusual event”, “threat”, “crime”, “emergency situations”, and so on interchangeably refer to a unsafe condition/situation.

The security device 106 can be an Artificial-Intelligence (AI) assisted security surveillance device placed inside or outside of the vehicle at a suitable location. For example, the security device 106 can be placed on a dashboard of the vehicle, below a rearview mirror of the vehicle, above the rearview mirror of the vehicle, at a commuter side of the vehicle, at a driver side of the vehicle, and so on. The security device 106 can be coupled to at least one sensor placed in the vehicle at the suitable locations. Examples of the at least one sensor can be, but not limited to, a media sensor/camera, a microphone, cameras, motion sensors, accelerometers, gyroscopes, shock sensors, IMU (Inertial Measurement Unit), ultrasonic sensors, light sensors, Infrared (IR) sensors, and so on.

The security device 106 can be configured to monitor the vehicle and surrounding of the vehicle in real-time. The security device 106 receives media (such as images, audio, videos, and so on) related to the vehicle and the surrounding of the vehicle using the at least one sensor. The media may include information about media related to interior of the vehicle (a cabin environment/a cockpit of the vehicle) and/or surrounding (outside) of the vehicle, activities of the users (the driver and the commuters), conditions of objects (such as camera, sensors, or the like) present in the vehicle, and so on. The activities of the users can be, but not limited to, gestures, voice, behaviors, and so on of the driver and the commuters. The security device 106 may also receive vehicle data and additional information by communicating with the at least one sensor. Examples of the vehicle data can be, but not limited to, speed of the vehicle, location of the vehicle, and so on. The additional information can be at least one of time, date, timestamps associated with the media, signal strength of the communication network supported by the security device 106, and so on. The security device 106 creates a set of data by appending the media with the vehicle data, and the additional information. The security device 106 communicates the created set of data to the server 108.

In an embodiment herein, the security device 106 can communicate the created set of data to the server 108 at pre-determined intervals of time or incase an event trigged manually or automatically from the security surveillance system 100. In an embodiment herein, the security device 106 can communicate the created set of data to the server 108 on occurrence of pre-determined events. In an embodiment herein, the security device 106 can communicate the created set of data to the server 108 as a live stream. In an embodiment, the security device 106 may include a pre-trained model of safe commute behavior for identifying the events. In an embodiment, the security device 106 may fetch the pre-trained model of safe commute behavior from the server 108. The pre-trained model of safe commuter behavior includes conditions/criteria such as, but not limited to, normal position of the driver and sitting position of the commuter, undistracted driving pattern of the driver, normal cockpit ambience sound level, threatening words (such as, “help”, “stop”, and so on), screaming, loud music, abusive language, pre-defined trip route, door lock status, normal vehicle speed. The security device 106 compares at least one of the media, the vehicle data, the additional information, and so on received from the sensors with the pre-trained model of safe commute behavior and checks for violation of any one of the criteria included in the pre-trained model of safe commuter behavior. The security device 106 considers the violation of any one of the criteria included in the pre-trained model of safe commuter behavior as the occurrence of the pre-determined events to communicate the created set of data to the server 108/the external entity 104/the user device 102.

The server 108 referred herein may be standalone server or a server on a cloud. Further, the server may be any kind of computing device such as those, but not limited to a personal computer, a notebook, a tablet, desktop computer, a laptop, a handheld device a mobile device, and so on. Although not shown, the server 108 can be a cloud computing platform that can connect with devices (the user devices 102, the external entity 104, and the security device 106) located in different geographical locations.

The server 108 can be configured to receive user details during a registration process initiated by the user(s) (the driver and the commuter(s)) for accessing at least one ride service. The ride service can be at least one of ride hailing services, ride sharing services, taxi ride services, bus services, and so on. Examples of the user details can be at least one of user name, phone number, email address, age, gender, picture, and so on. The server 108 further enables the user to select a unique user identity (ID) on receiving the user details. The unique user ID can be at least one of a unique name, an avatar, and so on. For security purposes, the user details (of the driver and the commuter) can be kept anonymous during an end-to-end communication initiated between the driver and the commuter(s). The unique user ID can be shared during the communication between the driver and the commuter(s) and/or a fleet operator. In an embodiment during the registration process, the server 108 can generate the unique user ID for the user based on the user details. The server 108 stores the user details along with the unique user ID in the storage device 110.

The server 108 can also be configured to receive vehicle details from the driver during the registration process. The vehicle details can be, but not limited to, vehicle number, vehicle type, information about the vehicle (such as, the vehicle has equipped with the security device 104, the vehicle has equipped with basic surveillance system such as camera, sensors, and so on, the vehicle has not equipped with the security device 104, or the like), and so on.

The server 108 can be further configured to schedule/initiate the ride for the commuter(s). The server 108 receives an initiate ride request from the commuter. The server 108 may also receives criteria along with the initiate ride request from the commuter. The initiate ride request can include at least one of the unique user ID associated with the commuter, location, ride time, and so on. The criteria can be for the vehicle with basic surveillance system, the vehicle equipped with the security device 104, vehicle type, and so on. On receiving the initiate ride request and the criteria, the server 108 checks the storage device 110 and selects the vehicles that meets the received criteria. On selecting the vehicles, the server 108 sends the initiate ride request to the drivers corresponding to the selected vehicles. On receiving a confirmation response from any one of the selected drivers, the server 108 determines a status of at least one of the security device 106 and the at least one sensor deployed in the corresponding vehicle to check for associated issues. If at least one issue is associated with at least one of the security device 106 and the at least one sensor deployed in the selected vehicle, the server 108 does not confirm the ride with the selected vehicle and selects other vehicle. If no issue is identified with the security device 106 and the at least one sensor deployed in the selected vehicle, the server 108 then communicates the confirmation details to the user device 102 of the commuter, so that the commuter can initiate the ride. The confirmation details include at least one of vehicle details (such as, a number, a type, and so on), details of the driver (unique user ID associated with the driver, arrival time, and so on).

The server 108 can be further configured to continuously communicate with the security device 106 on initiation of the ride and collects the set of data (that is created using at least one sensor) related to the vehicle from the security device 106. The sever 108 can store the collected set of data in the storage device 110. In an embodiment, the server 108 can provide the collected set of data to at least one of the commuter(s), the driver, the one or more third parties (friends and family), the law enforcement agencies, and so on in real-time. In an embodiment, the server 108 can provide the collected set of data (can be, the media, the vehicle data, and the additional information) to the fleet monitoring center/surveillance center (the external entity 104). The fleet monitoring centre can further detect the unusual activity from the set of data and provides information about the unusual event along with the received set of data to at least one of the commuter(s), the driver, the one or more third parties (friends and family), the law enforcement agencies, and so on.

The server 108 can be further configured to detect the unusual activity during the ride. The server 108 receives the set of data from the security device 106 deployed in the vehicle and identifies at least one event by analyzing the received set of data. In an embodiment, the server 108 may use at least one of the AI and the machine learning methods to analyze the set of data. The server 108 analyzes the set of data to determine user related data, object related data, a change in the vehicle data (such as change in speed, route, and so on). The user related data can be, but not limited to, labeled characteristics of the users (the driver and the commuter(s)) present in the vehicle, age, gender, and cultural appearance of the users, faces of the users, emotional expressions of the detected users, and so on. The object related data can be, but not limited to, presence of at least one unauthorized object in the vehicle, damage caused to the at least one object present in the vehicle, and so on. The server 108 may also detect and label the location of a scene within the given media. The server 108 also monitors the media related to the interior of the vehicle for any anomaly and/or an unidentified/unauthorized presence (such as a person/object) in the vehicle. The server 108 can identify the event based on at least one of the user related data, the labeled location of the scene of the media, the presence of any anomaly and/or an unidentified/unauthorized presence (such as a person/object) in the vehicle, the object data, the change in the vehicle data, and so on.

The server 108 monitors and analyzes the identified event. The event can be analyzed as at least one of an event triggered by other devices present in the vehicle, the sensors, manually by the commuter(s), manually by the driver or the like, the unusual activity/event, and so on. The server 108 may also analyze the identified event as the unusual event by communicating with law enforcement agencies (the external entity 104). The server 108 further transmits the detected unusual activity to the fleet management centre 104, which can share information about the unusual activity to at least one of the commuter(s), the driver, the one or more third parties (friends and family), the law enforcement agencies, and so on.

The server 108 can be further configured to generate the emergency alerts on detecting that the analyzed event is the unusual activity. The server 108 communicates the emergency alert to the at least one of the commuter(s), the driver, the one or more third parties (friends and family), the law enforcement agencies, and so on directly. The server 108 can also store information about the unusual activity and the associated emergency alerts in the storage device 110.

In an embodiment, the server 108 can be the security device 106 as illustrated in FIG. 1b. The security device 106 can perform at least one function of the server 108 locally. In an example herein, the function can at least one of identifying the event using the set of data created using the sensors, analyzing the identified event as the unusual activity, alerting the at least one external entity 104 about the identified unusual activity, and so on.

The storage device 110 stores at least one of the user details, the vehicle details, the set of data created using the at least one sensor, the detected unusual activities, information about the external entity 104 registered for each user, the emergency alerts created for the unusual activities, and so on. The storage device 110 can be at least one of a database, a memory, file storage, cloud storage, an edge server, and so on.

FIG. 1 shows exemplary blocks of the security surveillance system 100, but it is to be understood that other embodiments are not limited thereon. In other embodiments, the security surveillance system 100 may include less or more number of blocks. Further, the labels or names of the blocks are used only for illustrative purpose and does not limit the scope of the embodiments herein. One or more blocks can be combined together to perform same or substantially similar function in the security surveillance system 100.

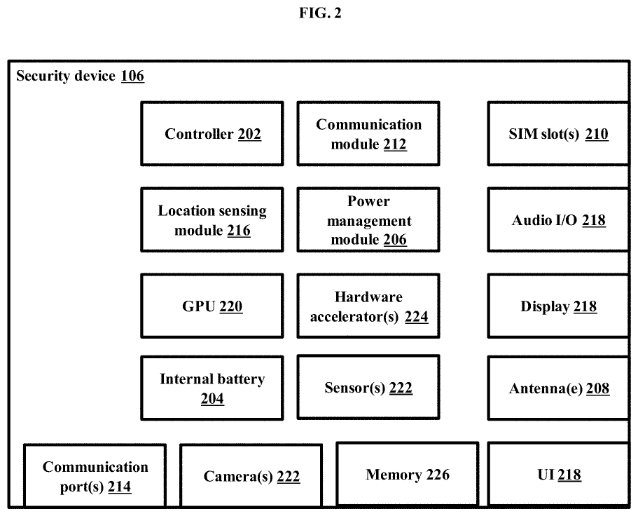

FIG. 2 is a block diagram illustrating various hardware components of the security device 106, according to embodiments as disclosed herein.

The security device 106 includes a controller 202, an internal battery 204, a power management module 206, one or more antennas 208, one or more Subscriber Identity Module (SIM) slots 210, a communication module 212, communication ports 214, a location sensing module 216, User Interface (UI) 218, a Graphic Processing Unit (GPU) 220, one or more sensors 222, hardware accelerators 224, and a memory 226.

The controller 202 can be at least one of a single processor, a plurality of processors, multiple homogenous cores, multiple heterogeneous cores, multiple Central Processing Unit (CPUs) of different kinds and so on. The controller 202 may be coupled to the other hardware components (204-226) of the security device 106 using at least one of the Internet, a wired network (a Local Area Network (LAN), a Controller Area Network (CAN) network, a bus network, Ethernet and so on), a wireless network (a Wi-Fi network, a cellular network, a Wi-Fi Hotspot, Bluetooth, Zigbee and so on) and so on. The controller 202 can be configured to regulate functions of the other hardware components (204-226) of the security device 106.

In an embodiment, the controller 202 can be coupled to at least one power supply/power sources (not shown) present in the vehicle that can provide power supply to the components (204-224). In an embodiment, the internal battery 204 can be configured to provide the uninterrupted power supply to the components of the security device 106 when an ignition and an Auto Carriage Connection (ACC) rail are powered OFF. The power management module 206 may be configured to manage the power supplied to the components of the security device 106.

The antennas 208 can be configured to receive signals from at least one external device (the user device 102, the external entity 104, the server 108, and so on). The antennas 208 may also coupled to a processing circuitry (not shown) that processes the received signals and provides the processed signal to the controller 102 for further processing/controlling the components of the security device 106. The antennas can be at least one of multiple internal or external primary antennas, diversity antennas, multiple-input and multiple-output (MIMO) antenna, and so on to increase at least one of receive sensitivity, transmission gain for connectivity with the at least one external device.

The SIM slots 210 can be configured to provide housing for one or more SIMs operated by same or different service providers. In an embodiment, the SIMs can be physical SIMs. In an embodiment, the SIMs can be embedded SIMs such as, but not limited to, an electronic SIM (eSIM), an Embedded Universal Integrated Circuit Card (eUICC) (that does not require physical access to change a carrier/communication network). The SIMs may support at least one communication network to enable the security device 106 to communicate with the least one external device. The communication network can be, but not limited to, 3rd Generation Partnership Project (3GPP), Long Term Evolution (LTE/4G), LTE-Advanced (LTE-A), 3GPP2, Code Division Multiple Access (CDMA), Frequency Division Multiple Access (FDMA), Time Division Multiple Access (TDMA), Orthogonal Frequency Division Multiple Access (OFDMA), General packet radio service (GPRS), Enhanced Data rates for GSM Evolution (EDGE), Universal Mobile Telecommunications System (UMTS), Enhanced Voice-Data Optimized (EVDO), High Speed Packet Access (HSPA), HSPA plus (HSPA+), Evolved-UTRA (E-UTRA), 5G based wireless communication systems, 4G based wireless communication systems, and so on.

In an embodiment, the security device 106 may also include the communication module 212 that enables the security device 106 to communicate with the at least one external device using at least one of a Wireless Local Area Network (WLAN), Wireless Fidelity (Wi-Fi), Wi-Fi Direct, Bluetooth, Bluetooth Low Energy (BLE), cellular communications (2G/3G/4G/5G or the like), and so on.

The communication ports 214 can be physical ports that can be configured to enable the security device 106 to connect with additional devices/modules. Examples of the communication ports 214 can be, but not limited to, general-purpose input/output (GPIO), Universal Serial Bus (USB), Ethernet, Camera Serial Interface (CSI), Display Serial Interface (DSI), and so on. Examples of the additional devices/modules can be, but not limited to, a CAN bus, On-board diagnostics (OBD) ports, cameras, microphones, speakers, modems, communication dongles, sensors, and so on.

The location sensing module 216 can be configured to track the location of the security device 106 using a suitable navigation systems such as, but not limited to, GPS (Global Positioning System), Global Navigation Satellite System (GNSS), Galileo, Triangulation, a GPS-aided GEO augmented navigation system (GAGAN navigation system), a BeiDou system and so on. The location sensing module 216 can be further configured to annotate the media (of the vehicle captured using the at least one sensor) with various type of the data provided by the navigation systems. The location can be in terms of geo-positioning coordinates.

The UI 218 can be configured to enable the users (the driver/commuters) to interact with the security device 106. The UI 218 can be used to provide information to the users in a form of text, visual alerts, audio alerts, and so on. The information can be at least one of the confirmation details (ride/trip information), public safety information, navigation, weather, pollution level, amber alert, local news, traffic information, route updates, the emergency alerts related to the unusual activity, and so on.

In an embodiment, the UI can be at least one of a display, at least one switch, a touch screen, a speaker, a microphone, and so on. In an example herein, the display can be at least one of a Liquid Crystal Display (LCD), Organic Light Emitting Diodes (OLED) display, Light-Emitting Diode (LED) display, and so on. In an example herein, the speaker can be used for at least one of two ways calling, alerting, announcement to the users, and so on. In an example herein, the microphone can be used for detecting at least one of ambiance noise, alert signal in the cockpit of the vehicle, and so on. The microphone can also be used for two way audio-video calling. In an embodiment, the UI can be at least one indicator such as, but not limited to, at least one light, an audio indicator, and so on.

The GPU 220 can be configured to accelerate a creation of the emergency alerts that can be displayed to the users using the UI 218 on detecting the unusual activity during the ride.

In an embodiment, the security device 106 may also include the sensors 222 in addition to the sensors located in the vehicle at different locations. Examples of the sensors 222 included in the security device 106 can be, but not limited to, cameras, infrared cameras, stereo cameras, ultrasonic sensors, IR sensors, light sensors, motion sensors, accelerometers, gyroscopes, shock sensors, IMU (Inertial Measurement Unit), and so on. The stereo cameras may be used for 3D imaging, depth sensing of object inside or outside the vehicle. The IR sensor may be used to capture images and videos of the vehicle in low light conditions. The ultrasonic sensor and the IR sensor may also used to detect obstacles blocking the Field of View (FOV) of one or more cameras, so that the user's occupancy in the vehicle can be detected. The light sensors can used for at least one of camera sensor adjustment for better image quality, image correction, white balancing, contrast balancing, and so on in real-time. The IMU and gyroscope may be used to measure angular rate, speed, acceleration along X,Y,Z axes, angular velocity about the X,Y,Z axes, and so on for identifying the driving behaviors and 3D position of the vehicle and notifying at least one of abrupt acceleration, too frequent acceleration, the vehicle involved in a crash, and so on. The security device 106 may use one or more cameras to provide the redundancies by covering all the angles inside and outside of the vehicle, so that better media can be captured. The cameras may also perform preprocessing of the captured media. The cameras may also decide whether to do or not do pre-processing of the media captured at a given time at camera level.

The hardware accelerator 224 can be configured to create the set of data, which can be used to detect the unusual activity. The hardware accelerator collects the data from the sensors 222 (or the sensors located in the vehicle at different locations) in a continuous manner. The data can be at least one of the media (related to the interior of the vehicle, surrounding of the vehicle, the activities of the users, and so on), the vehicle data, the additional information (such as time, date, timestamps associated with the media, signal strength of the communication network or the like), and so on. The hardware accelerator 224 may also collect the data from the location sensing module 216 to detect the location of the vehicle/security device 106. The collected data can be raw data. In an embodiment, the hardware accelerator 224 applies at least one correction method/technique on the raw data to create the set of data. Examples of the correction method/technique can be, but not limited to, white balancing, stabilization, image correction, contrast balancing, and so on. The hardware accelerator 224 can provide the created set of data to the controller 202, which communicates the created set of data to the server 108 for detecting the unusual activity during the ride using the communication module 214.

The memory 226 can store program code/program instructions to execute on the components of the security device 106 to perform one or more steps for monitoring the vehicle and surrounding of the vehicle. The memory 226 can also store the data collected from the sensors 222, the created set of data, and so on. In an embodiment herein, the memory 226 can be an internal memory. In an embodiment herein, the memory 226 can be an expandable memory connected to the security device via a memory slot. Examples of the memory can be, but not limited to, NAND, embedded Multi Media Card (eMMC), Secure Digital (SD) cards, Universal Serial Bus (USB), Serial Advanced Technology Attachment (SATA), solid-state drive (SSD), and so on. Further, the memory 226 may include one or more computer-readable storage media. The memory 226 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 226 may, in some examples, be considered a non-transitory storage medium. The term “non-transitory” may indicate that the storage medium is not embodied in a carrier wave or a propagated signal. However, the term “non-transitory” should not be interpreted to mean that the memory 226 is non-movable. In some examples, the memory 226 can be configured to store larger amounts of information than the memory. In certain examples, a non-transitory storage medium may store data that can, over time, change (e.g., in Random Access Memory (RAM) or cache).

In an embodiment, the security device 106 may be connected to an external remote using at least one of cellular networks, Bluetooth, Wi-Fi, IR, and so on. The external remote may allow the users present in the vehicle to control applications and features of the security device 106 locally. Examples of the features/applications can be, but not limited to, video/audio recording features, an enabling feature to enable the ride/trip in a sleep mode, a notify feature, and so on. In an example herein, the enabling feature may enable the ride/trip in the sleep mode when the commuter(s) fall asleep. In the sleep mode, the security device 106 continuously communicates the created set of data to the third party/external entity 104/or the like), providing information about an occurrence of each activity during the ride. In an example herein, the notify feature enables the security device 106 to notify about at least one of the route change, turning OFF of an engine of the vehicle by the driver, stopping the vehicle, by the driver, for a certain duration, and so on to the third party/external entity 104/or the like (in a form of audio alerts, visual alerts, text alerts, or the like).

FIG. 2 shows exemplary blocks of the security device 106, but it is to be understood that other embodiments are not limited thereon. In other embodiments, the security device 106 may include less or more number of blocks. Further, the labels or names of the blocks are used only for illustrative purpose and does not limit the scope of the embodiments herein. One or more blocks can be combined together to perform same or substantially similar function in the security device 106.

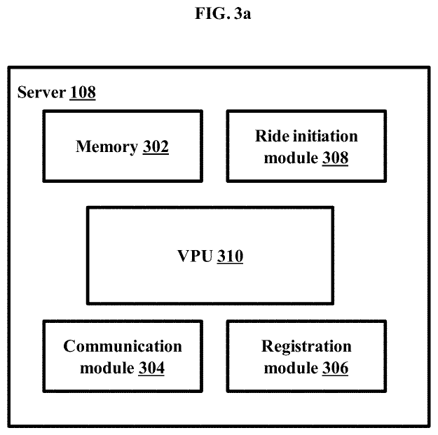

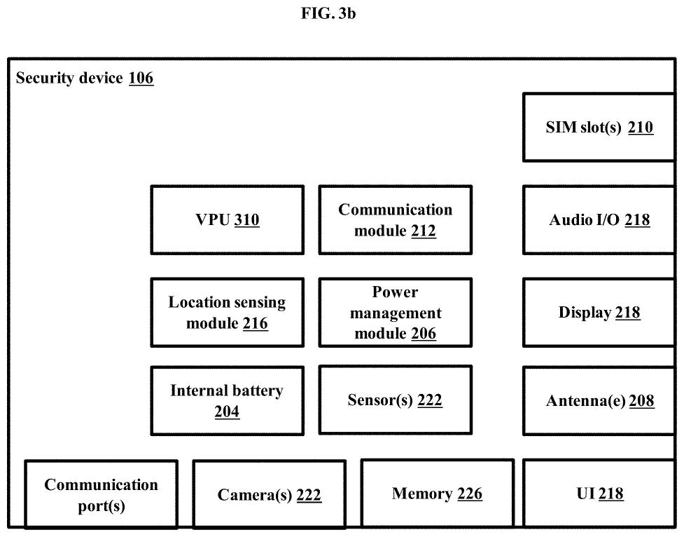

FIG. 3a is a block diagram illustrating various hardware components of the server 108, according to embodiments as disclosed herein. The server 108 includes a memory 302, a communication module 304, a registration module 306, a ride initiation engine 308, and a Vision Processing module (VPU) 310. The server 108 can provide a ride tracking application to the users that can enable the users to access the ride services provided by the security surveillance system 100 as the commuters or the drivers. The server 108 can also enable the users to access the ride services by connecting to a browser.

The memory 302 can store program code/program instructions to execute on the components of the server 108 to perform one or more steps for initiating the ride for the commuters and detecting the unusual activity during the ride. In an embodiment, the memory 302 can also store the user details (such as the name, gender, age, phone number, email address, and so on), that are provided by the users during the registration process. In an embodiment, the memory 302 can also store information related to the vehicles associated with the drivers, vehicle details (such as, vehicle type, location of the vehicles, status of the security device 106 and the sensors positioned in the vehicles and so on). In an embodiment, the memory 302 also stores the ride tracking application that can be provided to the users to access the ride services.

The communication module 304 can be configured to enable the server 108 to communicate with the at least one external device 104 (the user device 102, the external entity 104, the security device 106, and so on).

The registration module 306 can be configured to initiate the registration process by communicating with the user device 102 associated with the at least one user (the driver or the commuter). The registration module 306 can receive the user details from the associated user device 102 through the ride tracking application. The registration module 306 generates the unique ID for the at least one user on receiving the user details. For security purposes, the generated unique ID can be used between the end-to end communication between the users (the drivers and the commuters), so that the safety can be ensured

In an embodiment, the registration module 306 assigns priority and sensitivity to each user for tracking during the ride based on the associated user details. Based on the priority, and the sensitivity, the registration module 306 generates an identifier as the unique ID to each user. Thus, the identifier/unique ID indicates the priority and/or sensitivity associated with the user. For example, the registration module 306 may assign higher priority to children and women and generate the unique ID based on the higher priority, so that such users may be continuously monitored giving more importance.

The ride initiation engine 308 can be configured to initiate the ride for the commuters on checking the status of the vehicle. The ride initiation engine 308 initially authenticates/verifies the commuter based on the credentials of the commuter (user name and password). On successful authentication of the commuter, the ride initiation engine 308 receives the initiate ride request and the criteria for scheduling the ride. The criteria can be for at least one of the vehicle with the security device 106, the vehicle with the sensors/cameras, vehicle type, required services (such as audio players, video players, Wi-Fi, AC, and so on), rating of the driver, and so on. The initiate ride request can include at least one of the unique user ID, source location, destination location, ride time, and so on. The ride initiation engine 308 can access the storage device 110 and obtain the details of the registered vehicles. Based on the source location of the commuter and the obtained details of the registered vehicles, the ride initiation engine 308 selects the vehicles that can satisfy the criteria specified by the commuter and the location constraint. Further, the ride initiation engine 308 further transmits the initiate ride request to the selected vehicles. The ride initiation engine 308 may receive the confirmation response from the user device 102 associated with the driver of one of the selected vehicles. On receiving the confirmation response, the ride initiation engine 308 determines the status of the at least one of the security device 106 and sensors deployed in the corresponding vehicle. In an embodiment, the ride initiation engine 308 automatically triggers a system check to determine the status of at least one of the security device 106 and sensors deployed in the corresponding vehicle. In an embodiment, the ride initiation engine 308 triggers the system check on receiving a request for system check from the commuter through the ride tracking application once the user has on boarded the vehicle. The ride initiation engine 308 performs the system check by executing a sample script on the security device 106 to verify all the features/functions of the security device 106 are operating correctly. For example, the security device 106 verifies if the security device 106 has GSM signal, if the security device 106 has proper cellular connectivity, if the camera of the security device 106 is operating/activated or not, if the sensors, antennas, and/or other functions of the security device 106 are functioning correctly, and so on. Based on the verification, the ride initiation engine 308 determines the status of the at least one of the security device 106 and sensors deployed in the corresponding vehicle.

If the determined status indicates at least one issue with the at least one of the security device 106 and the sensors (for example; inactive security device 106 and the sensors), the ride initiation engine 308 does not confirm the corresponding vehicle for the commuters to ride. The ride initiation engine 308 further transmits the ride initiation request to other selected vehicles.

If the determined status indicates no issues with the at least one of the security device 106 and the sensors (for example; proper working of the security device 106 and the sensors), the ride initiation engine 308 confirms the ride and communicates confirmation details to the commuter to take up along with the confirmation message to the commuter. The confirmation details can include information such as, but not limited to, the unique user ID of the driver, phone number of the fleet/vehicle operator (who can enable the commuter to contact the driver), details of the confirmed vehicle (vehicle number, vehicle type, and so on), source location, destination location, source location arrival time, route, expected destination reachable time, and so on.

In an embodiment, the server 108 may include the VPU 310 as illustrated in FIG. 3a, that can be configured to detect the unusual activity during the ride and alert the detected unusual activity to the external entity 104. In an embodiment, the security device 106 may include the VPU 310 as illustrated in FIG. 3b to detect the unusual activity during the ride and alert the detected unusual activity to the external entity 104.

In an embodiment, the VPU 310 can be at least one of a single processer, a plurality of processors, multiple homogeneous or heterogeneous cores, multiple CPUs of different kinds, special media, and other accelerators. Further, the plurality of processing units 310 may be located on a single chip or over multiple chips. In an embodiment, the VPU 310 combines the functionality of the controller 202, the GPU 220, the hardware accelerator 224 and so on.

In an embodiment, at least one technique/method may be executed on the VPU 310 to detect the unusual activity during the ride and to alert the detected unusual activity to the external entity 104. In case of presence of the VPU 310 in the security device 106, the VPU 310 may access the server 108 to obtain the at least one technique/method. The supported at least one technique/method can be applied on applications that require real-time inferences. Examples of the at least one technique can be, but not limited to, image processing techniques, AI, machine learning, and so on. In an embodiment, the VPU 310 may also support multiple techniques/methods such as, but not limited to, Computer Vision (CV) techniques, Neural Networks, Deep Neural networks (DNNs), Convolutional neural network (CNN), Deep Learning, training data sets, and so on. Further, the memory 302/226 can store the program code/program instructions related to the at least one supported technique, which can be executed on the VPU 310 independently with minimal or no external server support. In an embodiment, the VPU 310 can be of a low-power architecture that enables an edge computing and does not require a connection to any external entities (such as the cloud), so that DNN inference applications stored in edge servers can also be executed on the VPU 310 for detecting the unusual activities during the ride. Thus, using the at least one above technique, the VPU can detect various activities and be able to flag the unusual activities automatically.

The VPU 310 analyzes the created set of data using the at least one above technique to detect the unusual activities during the ride. The created set of data may include the media related to the vehicle and surrounding of the vehicle, the media related to the activities of the users (the drivers/the commuters), the vehicle data (such as speed, location of the vehicle, or the like), the additional information (such as timestamps associated with each scene of the media, date, signal strength of the supported communication network or the like), and so on. In an embodiment, if the server 106 is configured to detect the unusual activity, then the VPU 310 receives the created set of data from the security device 106. In an embodiment, if the security device 106 is configured to detect the unusual activity, then the VPU 310 receives the created set of data from the hardware accelerators 226.

The VPU 310 can perform at least one action on the created set of data for analyzing. The action can be at least one of text summarization, media properties processing, web detection, object localizer, and so on. The VPU 310 can perform the at least one action using at least one of the AI, the machine learning method, and so on. The VPU 310 can analyze the set of data to determine the object related data, the user related data, the change in the vehicle data, and so on.

The VPU 310 analyzes the set of data and detects the at least one object present in the vehicle. In an embodiment, the VPU 310 uses the at least one method/technique such as, but not limited to, DNN, CNN, Single Shot Detection (SSD), machine learning, AI, CV techniques, and so on to identify, detect and track the at least one object present in the vehicle. On detecting the at least one object (such as camera, sensor, and so on), the VPU 310 performs labeling of the at least one object and determines the object related data. The object related data can be at least one of any unidentified/unauthorized object present in the vehicle, condition/status of the at least one object, and so on.

The VPU 310 analyzes the set of data and detects the at least one user present in the vehicle. In an embodiment, the VPU 310 uses the at least one method/technique such as, but not limited to, DNN, CNN, machine learning, AI, CV techniques, and so on to detect the at least one user present in the vehicle. On detecting the at least one user, the VPU 310 detects the user related data. The user related data can be, but not limited to, the characteristics of the at least one user, the emotions of the at least one user, the activities of the at least one user, presence of the unauthorized/unidentified at least one user and so on.

For detecting the characteristics of the at least one user, the VPU 310 recognizes the face of the at least one user using a suitable face recognition technique. The VPU 310 further performs labeling of the at least one user. In an embodiment, the VPU 310 performs dense caption labeling of the at least one user and/or at least one object. Based on the labeling of the at least one user and the detected face, the VPU 310 determines the characteristics of the at least one user present in the vehicle. Examples of the characteristics of the at least one user can be at least one of a number of users present in the vehicle, age, gender, cultural appearances of the at least one user, and so on.

For detecting the emotions, the VPU 310 processes the detected face of the at least one user by performing at least one of scaling, cropping, filtering, background removal methods on the detected face. The VPU 310 further applies a suitable feature extraction method on the processed face to extract and classify features of the detected face. The VPU 310 then compares the classified features with a set of trained features of the face, which is labeled with an emotion and detects the emotions of the detected face of the at least one user. Examples of the emotions can be, but not limited to, angry, fear, surprise, sad, disgust, happy, neutral, and so on.

The VPU 310 detects the activities of the at least one user (the driver and/or the commuters) based on the set of data/media. The VPU 310 maps the set of data/media with a pre-trained model (that include a mapping of the activities with the corresponding set of data/media) to detect the activities. The activities can indicate at least one of gesture, expressions on the face of the at least one user, behavior, interactions, speech of the at least one user. Examples of the activities can be, but not limited to, panic expression on the face of the at least one user, screaming sound, speech interactions in loud volume, the at least one user is using abusive language/threatening words, and so on, the at least one user is using words such as “help”, “stop”, and so on, the driver is not present in a respective seat, the driver is interacting with the user device while driving (speaking over a call, browsing the Internet, watching videos, and so on), the driver is not paying attention on road, the commuter is speaking over the call, the commuter is interacting with another commuter/driver present in the vehicle, and so on.

For detecting the presence of the unauthorized/unidentified at least one user, the VPU 310 access the storage device 110 to obtain an image of the face of the at least one user (the driver and/or the commuter who has initiated the ride) that is already stored during the registration process. The VPU 310 matches the detected face with the stored image of the face. Based on successful match, the VPU 310 confirms that the at least one user is registered user and/or the at least one user is the user who has initiated the ride. Based on unsuccessful match, the VPU 310 determines the presence of the unidentified/unauthorized user present in the vehicle during the ride. The VPU can also detect and label the location of the scene within the media included in the created set of data.

The VPU 310 further analyses the vehicle data included in the set of data and compares the set of data with the previously stored data (in the storage device 110 and/or the memory 302/226) to determine the change in the vehicle data. The change in the vehicle data can be at least one of change in the vehicle speed, change in the pre-defined route, and so on.

Based on the user related data, the object related data, and the change in the vehicle data, the VPU 310 detects the at least one event in the vehicle. Examples of the events can be, but not limited to, the commuter(s) entering the vehicle, activities of the driver and the commuter(s) (for example: change in sitting position of the at least one user, fatigue detection of the driver, body posture of the at least one user that is not in an normal behavior, and so on), interaction between the activities of the driver and the commuter(s), conditions of objects (such as sensors, cameras, and so on) present in the vehicle, route updates, traffic updates, and so on.

The VPU 310 monitors and analyzes the event detected from the created set of data (using the at least one sensor). The VPU 310 compares the detected event with a pre-defined list of the events and detects the identified event as at least one of an event triggered by other devices present in the vehicle, the sensors, manually by the commuter(s), manually by the driver or the like, unusual activity/event, and so on. The unusual activity/event can be an event indicating a change/anomaly in the vehicle data, the activities of the users (the driver and/or the commuter(s)) or the like, an event triggered on detecting an accident and so on. Examples of the unusual events can be, but not limited to, the commuter has entered a wrong vehicle/cab, unusual driver activities (such as the driver is intoxicated and/or drowsy, the driver is not paying the attention on the road, the driver is speaking over the mobile phone, fear on the face of the driver, and so on), the driver or co-passenger/commuter misbehavior, the commuter or the driver refused to follow guidelines, presence of unauthorized commuter(s)/object(s) in the vehicle, damage caused to the vehicle ambience, obstructions to the camera(s)/sensor(s), tampered camera(s)/sensor(s), and so on.

The VPU 310 further generates the emergency alerts on detecting the unusual activity/event. The VPU 310 communicates the emergency alerts to the external entity 104 for taking necessary actions. The emergency alert can be in a form of at least one of a push notification, a text alert, an e-mail alert, a voice based alert, live streaming of the event occurring inside the vehicle, and so on. The VPU 310 may also communicate relevant data along with the emergency alert to the at least one external entity 104. Examples of the relevant data can be, but not limited to, media, images, location, information about the users present in the vehicle, and so on.

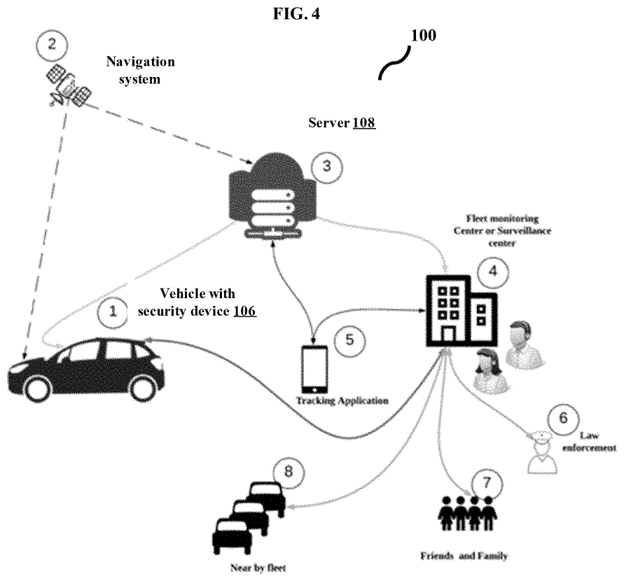

FIG. 4 depicts an example security surveillance system 100, according to embodiments as disclosed herein. The security surveillance system 100 may include the vehicle that is equipped with the security device 106 (1). The security device 106 creates the set of data (the media, the vehicle data, the additional information (such as timestamps, time, date, and so on) by collecting and performing correction action on the raw data collected from the sensors present in the vehicle at different location or using its associated sensors 222. The security device 106 may coupled with the navigation system (2) to track the location.

The security device 106 may send the created set of data by appending with the location to the server 108 (3). The server 108 may use at least one of the AI and the machine learning method to detect the unusual activity in the vehicle during the ride by continuously receiving and monitoring the set of data from the security device 106. On detecting the unusual activity, the server 108 may communicate the information about the unusual activity to the fleet monitoring center/surveillance center (the external entity 104) (4). On receiving the information about the unusual activity, the server 108/fleet monitoring center 104 provides the emergency alerts through the ride tracking application (5) to the users (the driver or the commuters), the one or more third parties (family and friends of the users) (7), the law enforcement agencies (the external entity 104) (6), nearby vehicles (8), and so on.

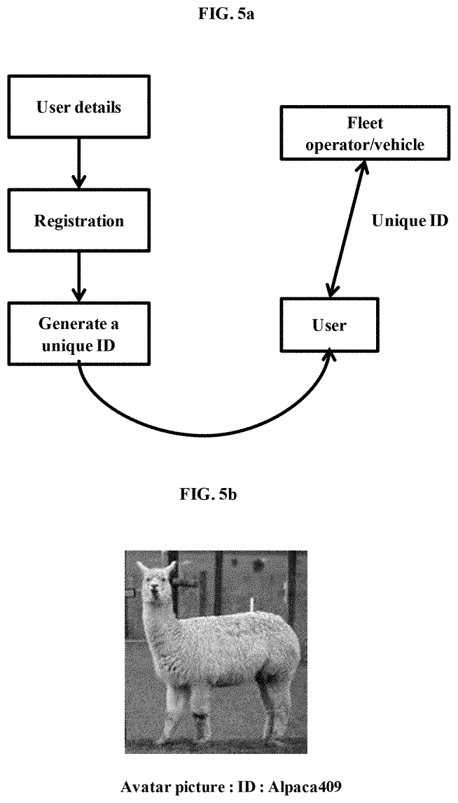

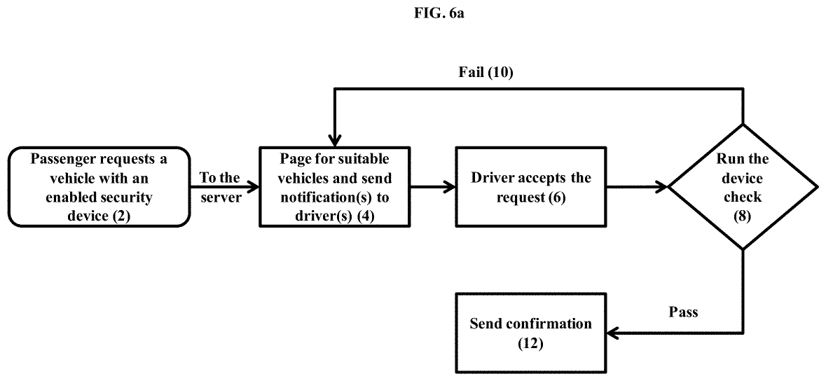

FIGS. 5a and 5b depict example scenarios of the registration process for accessing the at least one ride service, according to embodiments as disclosed herein. As illustrated in FIG. 5a, the at least one user (the driver or the commuters) may initiate the registration process by communicating with the server 108 using the ride tracking application. During the registration process, the server 108 receives the user details (such as user name, contact number, age, real name, gender, picture/image, and so on). The server 108 stores the received user details in the storage device 110 or the memory 302.

The server 108 builds a profile of the registered user using the registered details along with the unique user ID. For security purposes, during entire end-to-end communication process between the users (the driver and the commuters) from the time of booking to end of trip, the unique user ID can be shared between the users and the user details such as user name, contact number, age, real name, gender, picture/image may always be kept secret. In an embodiment, based on the user name registered by the user, the server 108 allows the user to select the unique user ID. The unique user ID can be at least one of the avatar and the ID. The unique user ID may not be the real name of the user.

In an embodiment, the server 108 may generate the unique user ID for the user based on the registered user name. Consider an example scenario, wherein the user is a commuter who registers with the server 108 for accessing the ride hailing service. During the registration process, the commuter has registered the user name as “XYZ”. Based on the registered user name, the server 108 generates the avatar (a picture) followed by the ID (Alpaca409) as the unique user ID for the commuter as shown in FIG. 5b.

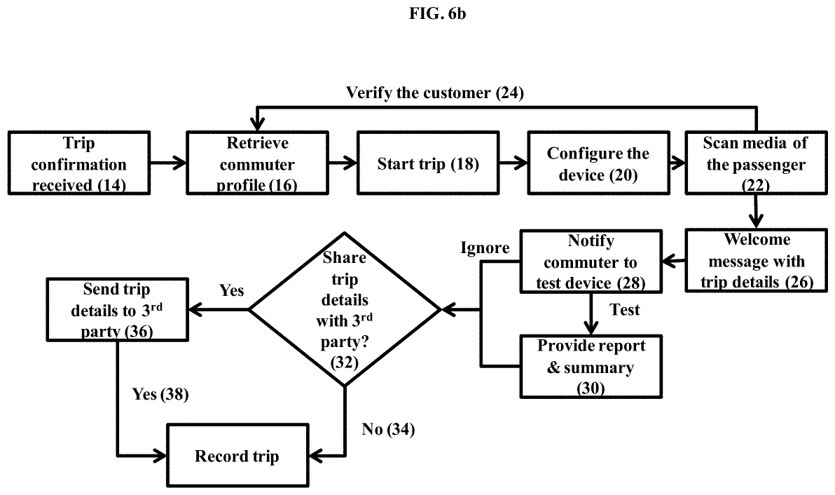

FIG. 6a is an example flow diagram illustrating a method for initiating the ride process, according to embodiments as disclosed herein.

For initiating the ride (for example; a taxi ride), the commuter can use the ride tracking application running on the associated user device 102 to transmit (step 2) the initiate ride request along with the criteria for the vehicle to the server 108. In an example herein, the criteria may indicate the request of the user for the vehicle that has equipped with the security device 106. On receiving the initiation request along with the criteria, the server 108 accesses the storage device 110 and selects the vehicles that have equipped with the security device 106. The server 108 sends (step 4) the notification for initiating the ride to the drivers associated with the selected vehicles. One of the vehicles may be paged with the initiate ride request and the corresponding driver accepts (step 6) the initiate ride request.

Once the initiate ride request is accepted by the driver, the server 108 performs (step 8) a device check to check the status of the security device 106/sensors/cameras present in the vehicle (to ensure proper working of the security device 106/sensors/cameras). If any issue is identified with the security device 106/sensors/cameras present in the vehicle, the server 108 does not confirm the vehicle to the commuter and checks (at step 10) for the other vehicle that can satisfy the criteria received from the commuter. If there is no issue identified with the security device 106/sensors/cameras present in the vehicle, the server 108 sends (at step 12) the confirmation details to the commuter for initiating the ride and the driver to pick up the commuter.

FIG. 6b is an example flow diagram illustrating a method for initializing the ride, according to embodiments as disclosed herein. Once the driver has received (at step 14) the confirmation details for the initialized ride/trip, the security device 106 deployed in the vehicle (selected for the ride) fetches (at step 16) the details of the commuter and/or driver from the server 108. The security device 106 initiates (at step 18) the ride by configuring (at step 20) the application or features of the security device 106 as per the initiate ride request received from the commuter.

The security device (at step 22) further scans media of the commuter to detect if the commuter has entered the vehicle and verifies the commuter. If the verification fails, the security device (at step 24) again fetches the details of the commuter from the storage device 110 to verify the commuter. Once the verification is successful, the security device 106 displays (at step 26) a welcome message with ride details (such as source/destination location, expected destination arrival time, route updates, and so on) to the commuter. The security device 106 also notifies (at step 28) the commuter to test the application/features/security device 106, so that the commuter can ensure the functionality of the security device 106 by running a quick system check on her or his device or the commuter can skip the process. After running the quick system check, the security device 106 provides (at step 30) a detailed report and summary on the application/features/security device 106 by indicating that the requested features are working as per the initiate ride request. In an embodiment herein, the commuter can also buy additional insurance or feature before/during the ride.

The security device 106 checks (at step 32) if the commuter wants to share the ride details with the third party/external entity 104. If the commuter does not want to share the ride details with anyone, then the security device 104 initiates (at step 34) the recording of the ride using the sensors.

If the commuter wants to share the ride details with the third party, the security device 106 transmits (at step 36) the ride details (such as driver details, vehicle details, starting point, the destination, route, time, and so on) to the third party/at least one external entity (such as the fleet management entity, a personal contact, and so on) and initiates (at step 38) the recording of the ride.

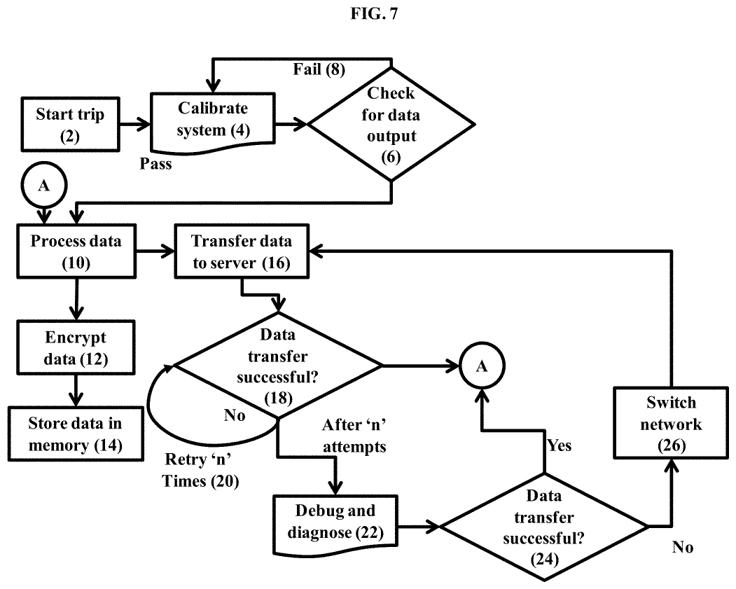

FIG. 7 is an example flow diagram illustrating a method for ride monitoring, according to embodiments as disclosed herein. As illustrated in FIG. 7, on initiation of the ride/trip (at step 2), the security device 106 initiates (at step 4) a calibration process of the sensors coupled to the security device 106. The security device 106 collects the data (the media, the vehicle data, and the additional information) from the sensors and checks (at step 6) for quality of the media and correct frame of the image. The security device 106 compares the collected media with the reference media to achieve high accuracy. If the comparison indicates that the collected media is of poor quality, then the security device 106 ignores the collected data and again collects (at step 8) fresh data from the sensors. Otherwise, the security device 106 processes (at step 10) the media based on at least one of an image stabilization method, usage of IR sensors, a white balancing method, a contrast balancing method, and so on. After processing the media, the security device 106 annotates the media with the vehicle data, and the additional information (such as communication network signal strength, location, timestamps, date, and so on) by creating the set of data. The security device 106 encrypts (at step 12) the set of data using suitable encryption methods and stores (at step 14) the encrypted data in the memory 226.

The security device 106 further transfers (at step 16) the created set of data to the server 108. The security device 106 checks (at step 18) if the communication network supported by the security device 106 can transfer the lossless data/the set of data (for example; using a circuit switched connection) to the server 106 successfully by monitoring the signal strength of the communication network in real-time. On detecting a failure of transfer of the data to the server, the security device 106 uses (at step 20) a retry loop of configurable value to try and re-send the set of data (using a packet connection) multiple times until a pre-configured maximum number is reached. The security device 106 saves (at step 22) the set of data for transferring to the server 108 later, when a minimum criterion to transfer the set of data to the server 108 is met. When the minimum criterion to transfer the set of data to the server 108 is met, the security device 106 checks (at step 24) if the communication network supported by the security device 106 can transfer the set of data (for example; using the packet connection) to the server 108 successfully. On detecting the failure of the transfer of the data to the server 108, the security device 106 sends (at step 26) notifications to the server 108 by switching the communication network (for example: through an alternate communication means (such as, a Short Messaging Service (SMS) or the like)) to notify the vehicle status/data.

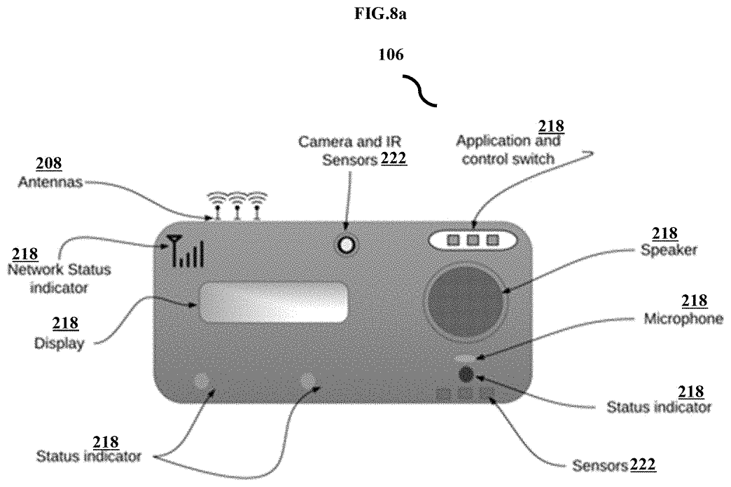

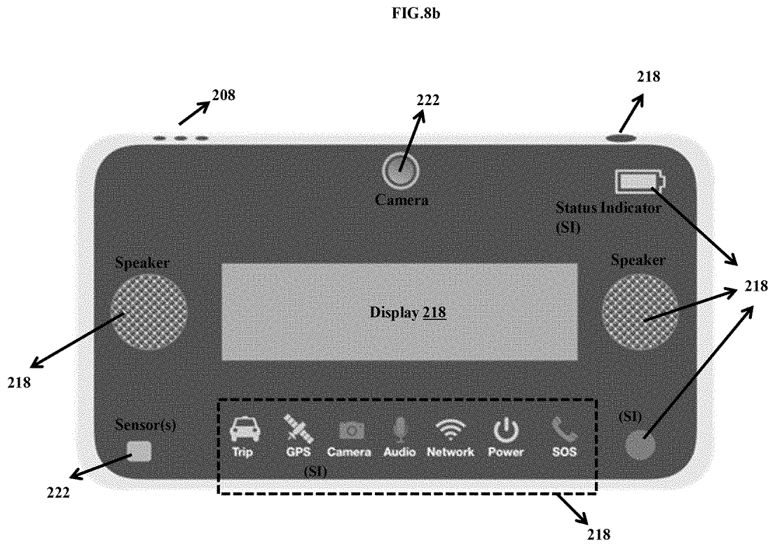

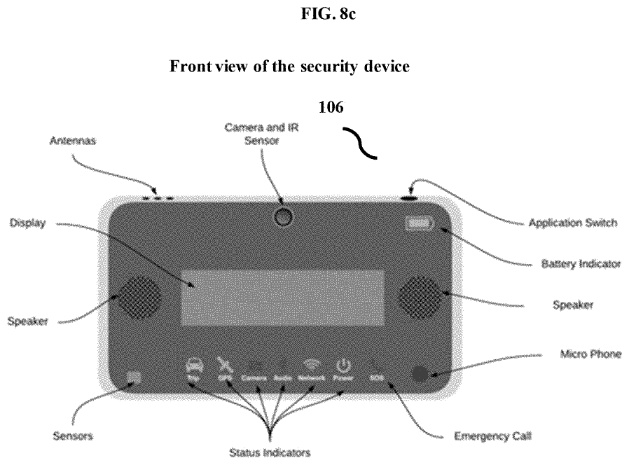

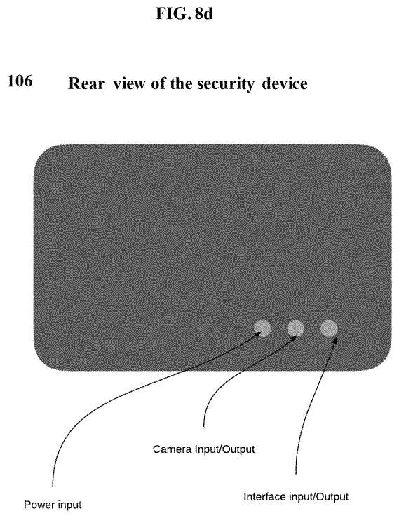

FIGS. 8a-8d depict an example security device 106, according to embodiments as disclosed herein. As illustrated in FIGS. 8a and 8b, the security device 106 includes the UI interface 218 that can be at least one of the display, the speaker, the microphone, the status indicator, and so on. The status indicator can indicate at least one of trip details, signal strength of the communication network, location information (for example; GPS data), an option for emergency call (SOS), a power button option, an audio option, a camera option, and so on. The UI interface 218 can be at least one application and control switch that enables the users to configure the applications/features of the security device 106.

The UI interface 218 can enable the users (the drivers and the commuters) to interact with the security device 106. Further, the UI interface 218 can be used to provide the emergency alerts to the users on detecting the unusual activities during the ride. The UI interface 218 also indicates the signal strength of the communication network supported by the security device 106.

The security device 106 further includes the antennas to receive the signals/data from the at least one external device. The security device 106 also coupled to the sensors such as cameras, IR sensors, and so on to monitor the vehicle and surrounding of the vehicle.

In an example, a front view of the security device 106 is illustrated in FIG. 8c. In an example, a rear view of the security device 106 is illustrated in FIG. 8d.

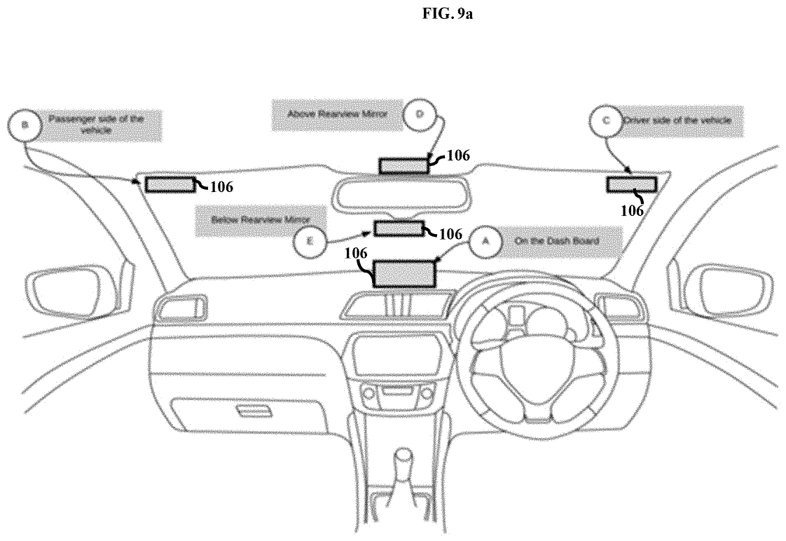

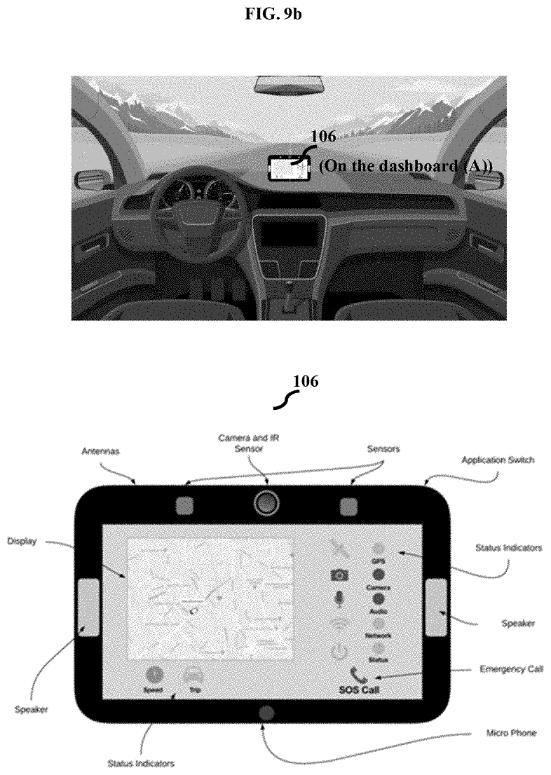

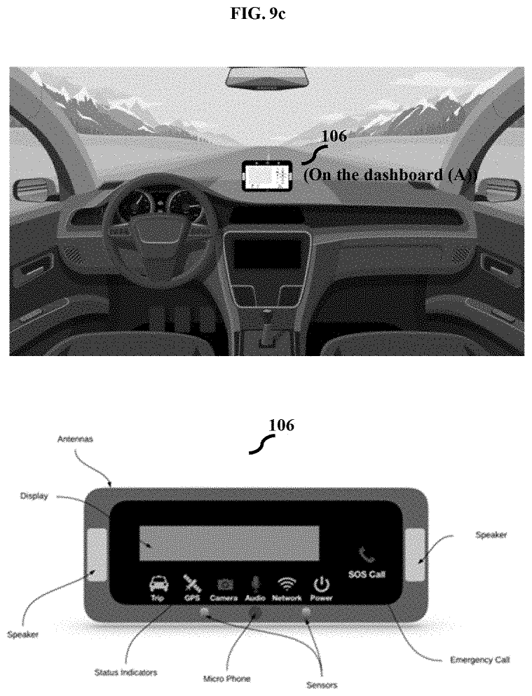

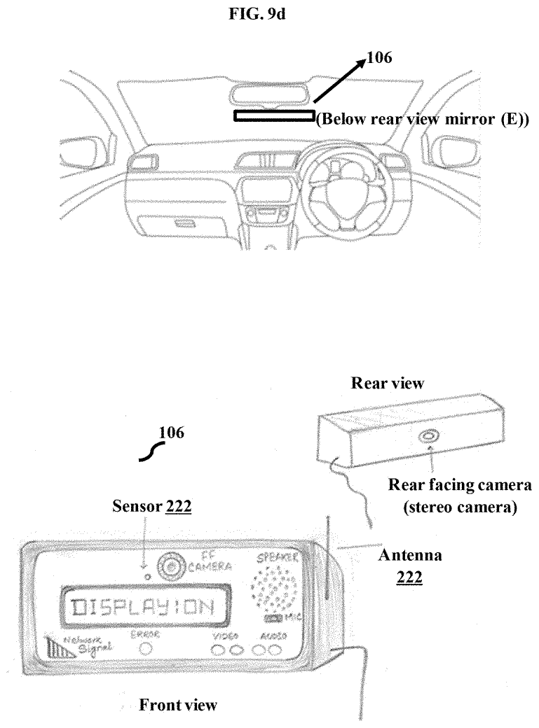

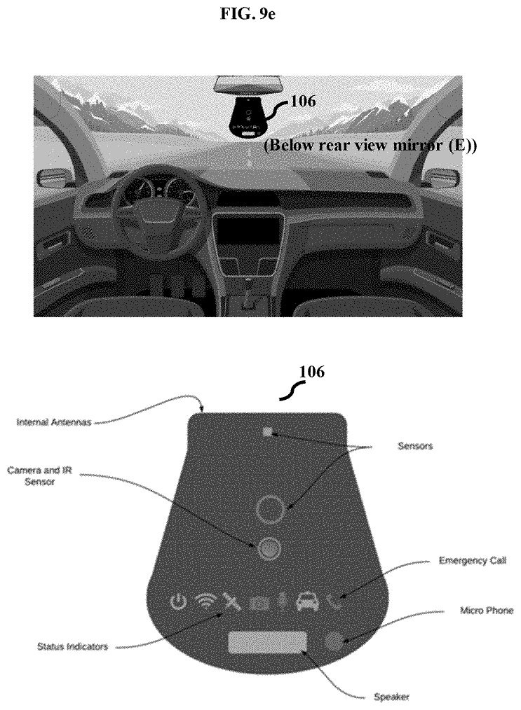

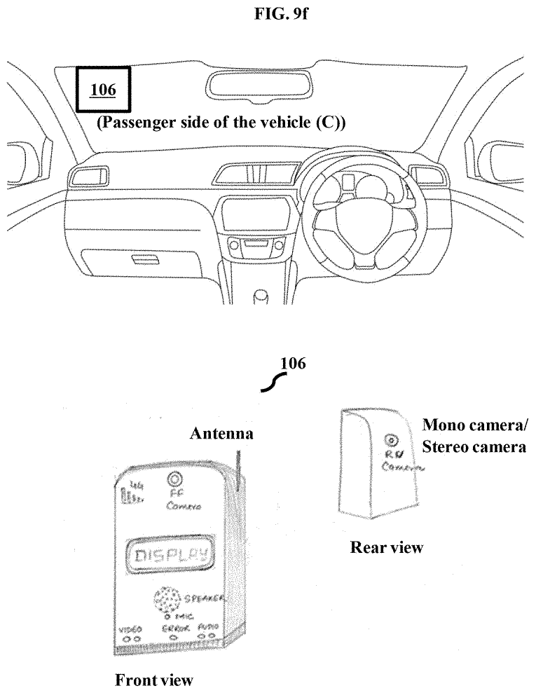

FIGS. 9a, 9b, 9c, 9d, 9e and 9f are example diagrams depicting the placements of at least one of the security device 106, the external camera, and the sensors in the vehicle, according to embodiments as disclosed herein.

The security device 106 along with the external camera, and/or sensors can be placed in the vehicle at different locations. In an example herein, the locations can be, but not limited to, on a dashboard (A) of the vehicle, at a commuter side of the vehicle (B), at a driver side of the vehicle (C), above rearview mirror (D), below rearview mirror (E), and so on as illustrated in FIG. 9a.

In an example herein, the security device 106 placed on the dashboard of the vehicle is illustrated in FIGS. 9b and 9c.

In an example herein, the security device 106 placed on below the rearview mirror of the vehicle is illustrated in FIGS. 9d and 9e.

In an example herein, the security device 106 placed at the commuter side of the vehicle is illustrated in FIG. 9f.

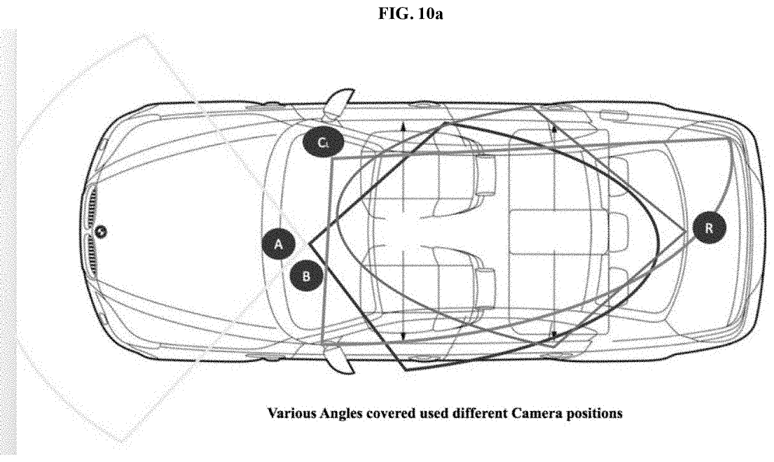

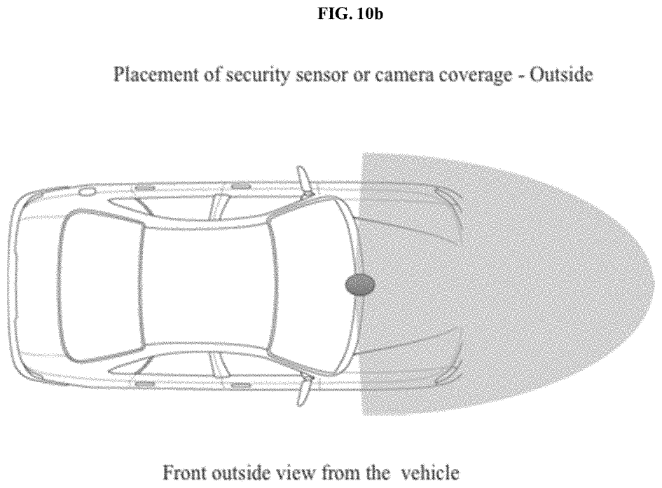

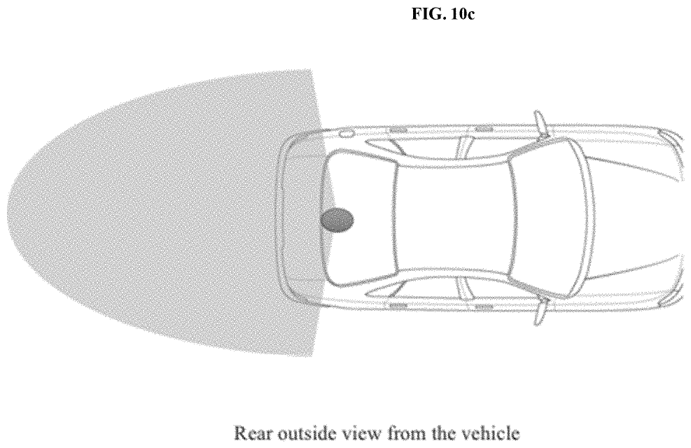

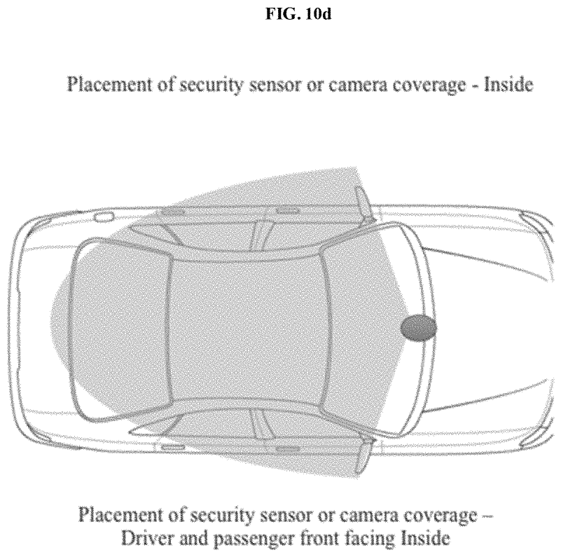

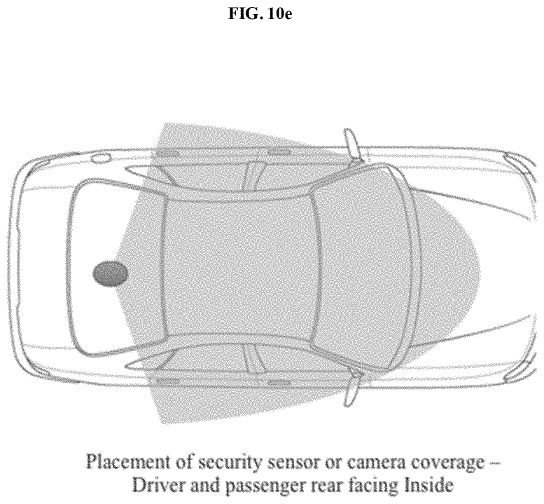

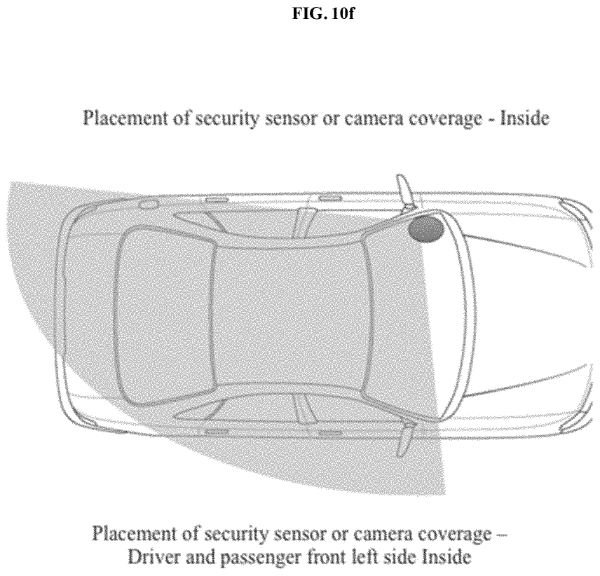

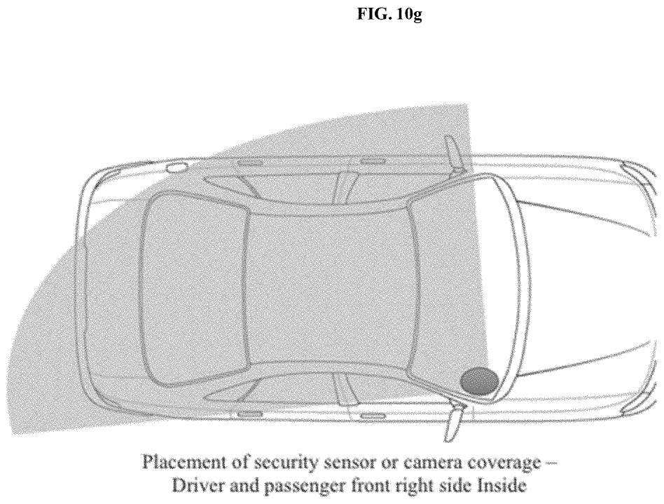

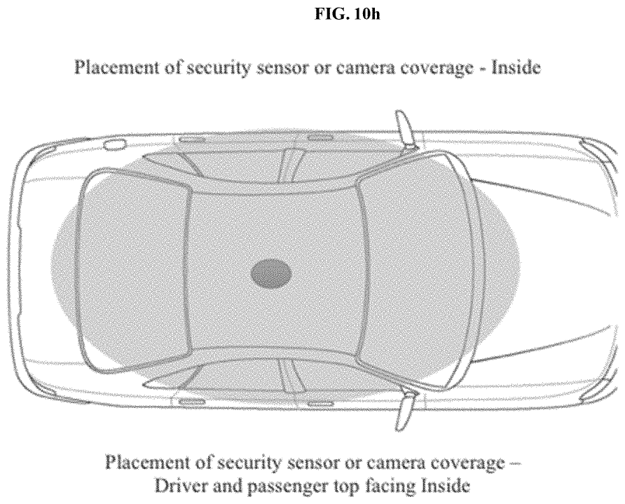

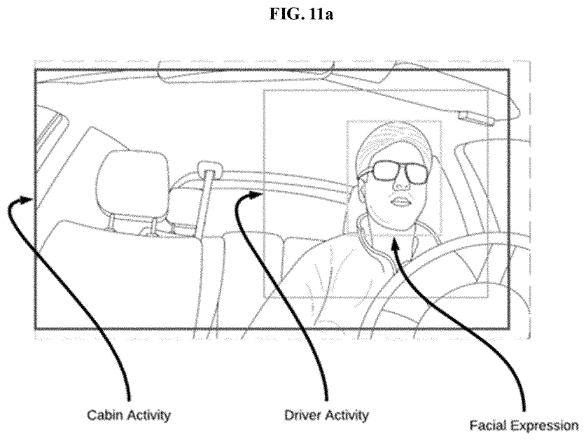

FIGS. 10a-10h are example diagrams depicting the placements of the camera/sensors in the vehicle, according to embodiments as disclosed herein. In an embodiment, the cameras/sensors can be placed in the vehicle at various locations by covering various angles for monitoring the vehicle and the surrounding of the vehicle as illustrated in FIG. 10a.

In an example herein, the cameras/sensors can be placed outside of the vehicle at a front end, so that cameras/sensors can monitor a front outside view of the vehicle as illustrated in FIG. 10b.

In an example herein, the cameras/sensors can be placed outside of the vehicle at a rear back end for monitoring the cockpit or the cabin environment of the vehicle from a rear outside view as illustrated in FIG. 10c.

In an example herein, the cameras/sensors can be placed inside the vehicle at the front end for monitoring the users (the driver and the commuter(s)) present in the vehicle who are facing at the front side of the cockpit as illustrated in FIG. 10d.

In an example herein, the cameras/sensors can be placed inside the vehicle at the rear back end for monitoring the users (the driver and the commuter(s)) present in the vehicle who are facing at the rear back end as illustrated in FIG. 10e.

In an example herein, the cameras/sensors can be placed inside the vehicle at a rear left side for monitoring the users (the driver and the commuter(s)) present in the vehicle at the left side and facing inside the cockpit as illustrated in FIG. 10f.

In an example herein, the cameras/sensors can be placed inside the vehicle at a right side for monitoring the users (the driver and the commuter(s)) present in the vehicle at the right side and facing inside the cockpit as illustrated in FIG. 10g.

In an example herein, the cameras/sensors can be placed inside the vehicle at a top end for monitoring the users (the driver and the commuter(s)) present in the vehicle who are facing at the top of the vehicle as illustrated in FIG. 10h.

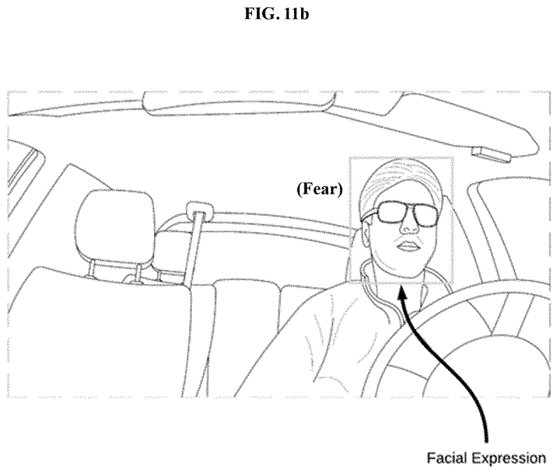

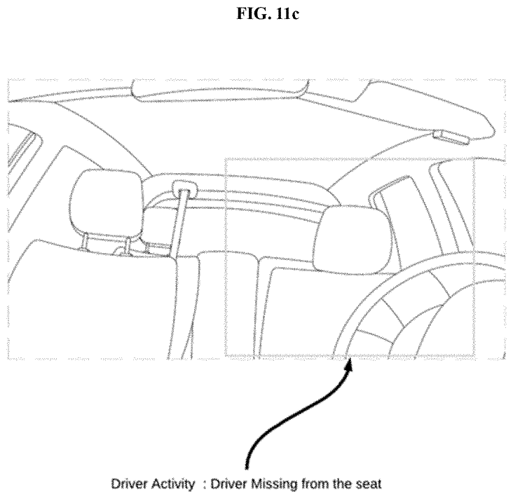

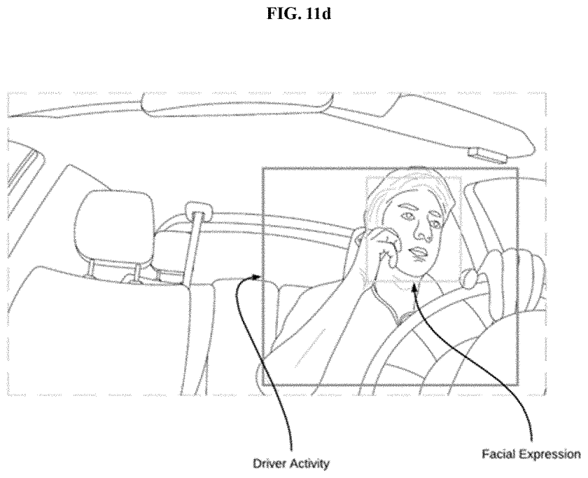

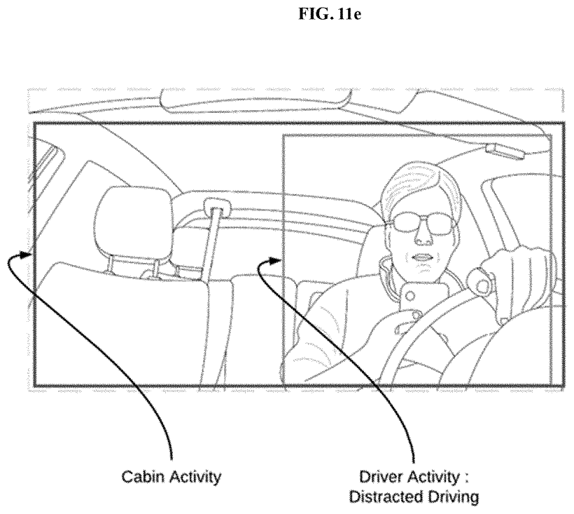

FIGS. 11a-11e depict example scenarios, wherein the security device 106 is monitoring the interior of the vehicle. The security device 106 can scan the interiors/capture the media of the interiors of the vehicle for driver activity, facial expression, passenger activity, passenger facial expressions, cabin environment, and so on.

In an example herein, from the scanned interiors/captured media, the driver activity can be detected as a normal activity as illustrated in FIG. 11a.

In an example herein, fear on the face of the driver is detected based on the scanned interiors/captured media as illustrated in FIG. 11b. The fear on the face of the driver can be detected as the unusual activity and accordingly the commuter/third party can be alerted.

In an example herein, from the scanned interiors/captured media, it can be detected that the driver is missing from the seat during the scheduled ride as illustrated in FIG. 11c. The driver missing from the seat can be detected as the unusual activity and accordingly the commuter/third party can be alerted.

In an example herein, from the scanned interiors/captured media, it can be detected that the driver is interacting with the user device 102 without paying attention on the road during the scheduled ride as illustrated in FIG. 11d.

In an example herein, from the scanned interiors/captured media, it can be detected that the driver is speaking over the user device during the scheduled ride as illustrated in FIG. 11e.

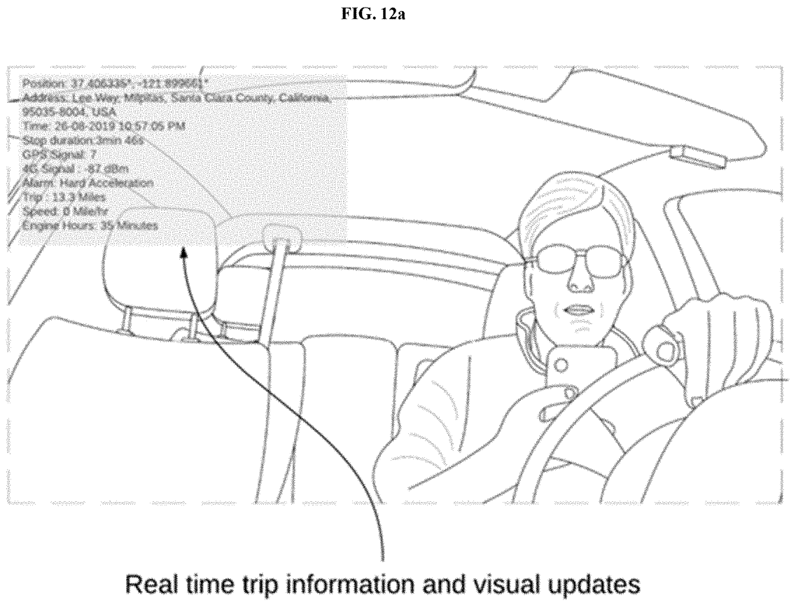

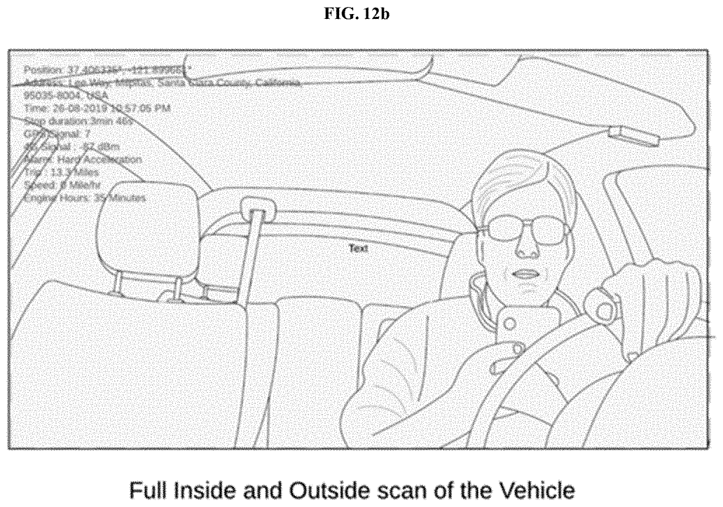

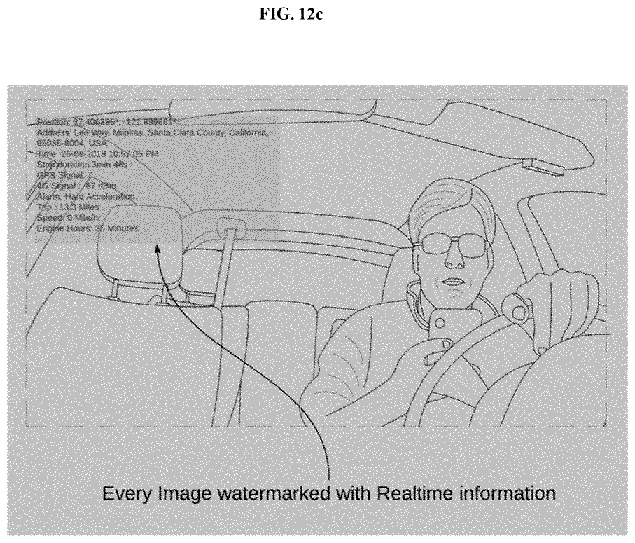

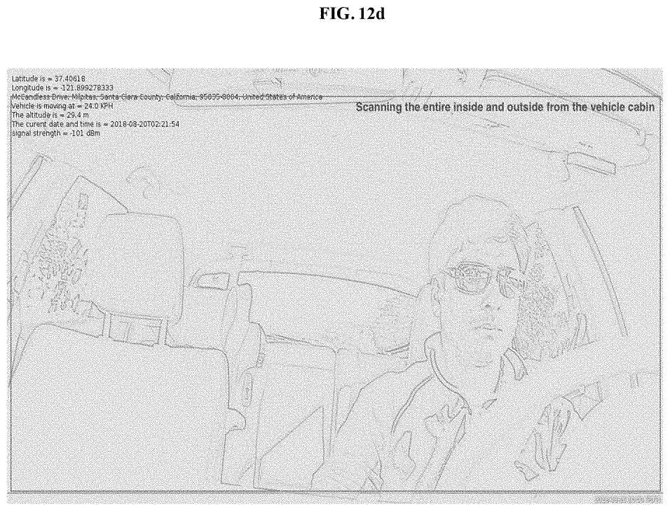

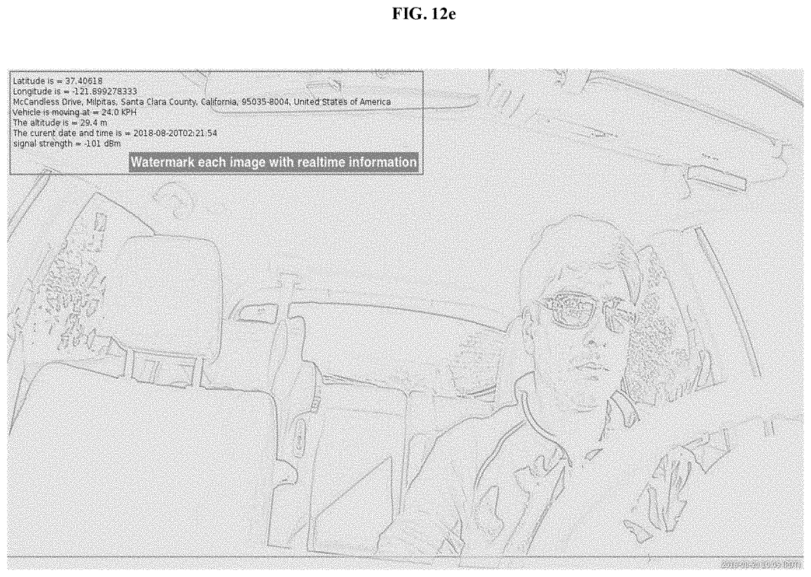

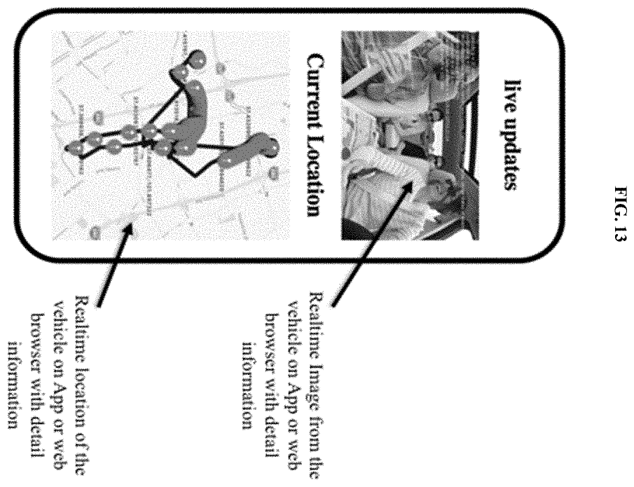

FIGS. 12a, 12b, 12c, 12d and 12e depict the media of the vehicle with real-time information, according to embodiments as disclosed herein. The media captured using the at least one sensor by scanning the entire inside and outside from the cabin environment of the vehicle can be appended with the vehicle data and the additional information as illustrated in FIGS. 12a-12e. Examples of the vehicle data can be, but not limited to, vehicle speed, location of the vehicle in terms of geo-positioning co-ordinates, and so on. Examples of the additional information can be, but not limited to, date, time, signal strength of the communication network supported by the security device 106 present inside the vehicle, and so on.

In an embodiment, the media can be an image and the image can be watermarked by appending with the real-time information as illustrated in FIGS. 12c. 12d and 12e.

FIG. 13 depicts an example scenario, wherein the user/third party is tracking the ride using the ride tracking application, according to embodiments as disclosed herein.

Consider an example scenario, wherein the third party is registered for monitoring the ride. An example UI of the ride application enables the third party to monitor the scheduled ride in real-time on receiving live updates from the server 108/security device 106/the fleet monitoring centre 104. In an example, the live updates can include at least one of real-time image of the interior of the vehicle (including the driver and the commuters), the vehicle data (speed, location, or the like), the additional information (such as signal strength, date, time, or the like). In an example, the live updates can be real-time location of the vehicle along with the additional information.

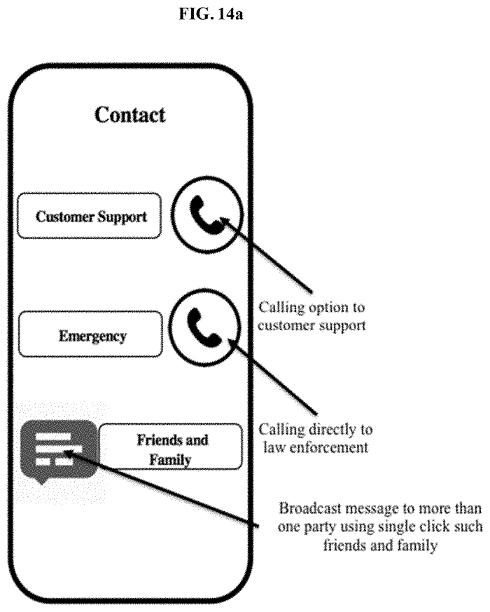

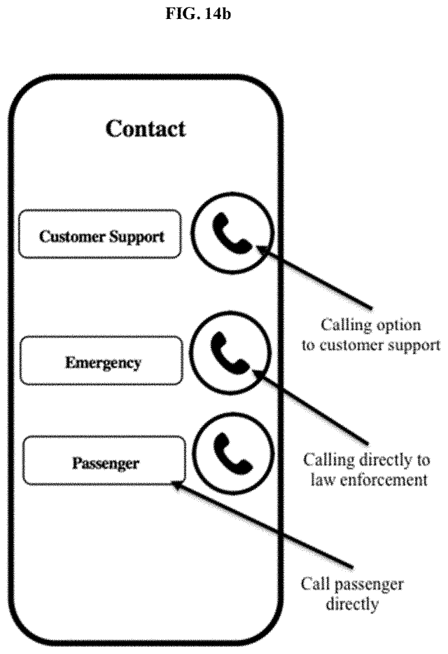

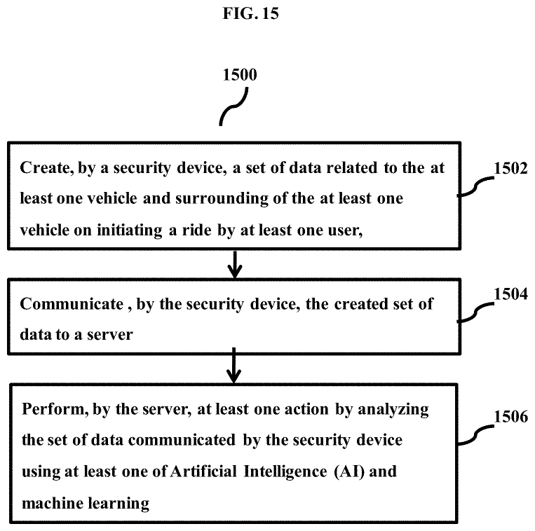

FIGS. 14a and 14b depict example UIs of the application, which enable the users/third party to interact with the external entities, according to embodiments as disclosed herein.

Consider an example UI of the application as illustrated in FIG. 14a, which enable a passenger/commuter to contact customer service, emergency services, friends and/or family. The passenger can be provided with a calling option, so that the passenger can contact a customer support, the law enforcement agencies directly for any updates, information, and so on or in case of any emergency situations. The passenger may also be provided with a messaging option, that enables the passenger to broadcast a message to the one or more third parties (friends and families) using a single click.

Consider an example UI of the application as illustrated in FIG. 14b, which enable a third party to contact the customer service, the emergency services, the passenger(s), and so on. The third party can be provided with a calling option to contact the customer service, and the law enforcement agencies directly for any updates, information, and so on or in case of any emergencies. The third party may also be provided with a calling option that enables the third party to directly contact the passenger in case of any emergencies.

FIG. 15 is a flow diagram 1500 illustrating a method for monitoring of the vehicle in real-time, according to embodiments as disclosed herein.

At step 1502, the method includes, creating, by the security device 106, the set of data related to the vehicle and surrounding of the vehicle on initiating the ride by the at least one user. The at least one user can be at least one of the driver and the commuter. The created set of data includes, the media related to the vehicle, the vehicle data, and the additional information (such as date, time, and so on).

At step 1504, the method includes communicating, by the security device 106, the created set of data to the server 108.

At step 1506, the method includes, performing, by the server 108, the at least one action by analyzing the set of data communicating by the security device 106 using at least one of AI, machine learning methods, and so on. The at least one action can be, communicating the set of data to at least one external entity 104, identifying at least one event based on the set of data communicated by the security device 106, communicating the identified at least one event to the at least one external entity 106; detecting at least one unusual activity based on the set of data communicated by the security device 106; and generating and transmitting at least one emergency alert to the at least one external entity 104 on detecting the at least one unusual activity.

The various actions, acts, blocks, steps, or the like in the method and the flow diagram 1500 may be performed in the order presented, in a different order or simultaneously. Further, in some embodiments, some of the actions, acts, blocks, steps, or the like may be omitted, added, modified, skipped, or the like without departing from the scope of the invention.

Embodiments herein intelligently monitor rides, when one or more users/parties are involved in a vehicle during the rides. The vehicle can be at least one of a private vehicle, a commercial vehicle, a public vehicle, and so on.

Embodiments herein ensure safety during the rides by capturing data from various sensors and cameras present in the vehicle and leveraging at least one method/technique to monitor the vehicle automatically with least amount of human involvement. The at least one method/technique can be at least one of an Artificial Intelligence (AI), Deep Learning, Computer Vision (CV) techniques, Internet of Things (IoT), real time connectivity, machine learning techniques, and so on.

Embodiments herein provide a security device that can be placed inside or outside the vehicle to track real time events/activities inside or outside of the vehicle by analyzing data collected from the various sensors of the device and using the at least one method such as, but not limited to, AI, machine learning techniques, and so on. The data can be at least one of activities of users (a driver and commuter(s)) present in the vehicle, vehicle data, and so on.

Embodiments herein detect threat/emergency situations/crime based on the tracked real time events and provide evidence, details to at least one of customers/commuters, a fleet management, a law enforcement agency, and so on.

The embodiments disclosed herein can be implemented through at least one software program running on at least one hardware device and performing network management functions to control the elements. The elements shown in FIGS. 1a-3b can be at least one of a hardware device, or a combination of hardware device and software module.

The embodiments herein disclose methods and systems for real-time monitoring of vehicles. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g. Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the spirit and scope of the embodiments as described herein.

What is claimed is:

1. A security surveillance system comprising:
a storage device;
a security device deployed in at least one vehicle; and
a server coupled to the storage device and the security device; wherein the security device is configured to:
create a set of data related to the at least one vehicle and surrounding of the at least one vehicle on initiating a ride by at least one user, wherein the at least one user includes at least one of at least one driver and at least one commuter; and
communicate the created set of data to the server;
wherein the server is configured to:
perform at least one action by analyzing the set of data communicated by the security device using at least one of Artificial Intelligence (AI) and machine learning.

2. The security surveillance system of claim 1, wherein the at least one action includes at least one of:
communicating the set of data communicated by the security device to at least one external entity;
identifying at least one event based on the set of data communicated by the security device;
communicating the identified at least one event to the at least one external entity;
detecting at least one unusual activity based on the set of data communicated by the security device; and
generating and transmitting at least one emergency alert to the at least one external entity on detecting the at least one unusual activity.

3. The security surveillance system of claim 1, wherein the security device is further configured to:
collect at least one of at least one media related to the at least one vehicle, vehicle data and an additional information using at least one sensor placed in the at least one vehicle;
perform at least one correction procedure on the collected at least media to enhance quality of the collected at least one media; and
create the set of data by appending the enhanced at least one media with at least one of the vehicle data and the additional information.

4. The security surveillance system of claim 3, wherein the at least one media provides information about at least one of activities of the at least one user present inside the at least one vehicle, conditions of at least one object present in the at least one vehicle, a cockpit of the at least one vehicle, and surrounding environment of the at least one vehicle.

5. The security surveillance system of claim 3, wherein the vehicle data includes at least one of vehicle speed, vehicle type, and vehicle location, wherein the additional information includes at least one of timestamps, date, and signal strength of the at least one communication network supported by the at least one security device.

6. The security surveillance system of claim 2, wherein the at least one device is further configured to:
process the created set of data using at least one of text summarization, properties of the at least one media, web detection, and object localizer to determine at least one of user related data, object related data, and a change in the vehicle data; and
identify the at least one event based on the determined at least one of the user related data, the object related data and the change in the vehicle data.

7. The security surveillance system of claim 6, wherein the user related data includes at least one of characteristics of the at least one user, the activities of the at least one user, emotions of the at least one user, and presence of at least one unauthorized user in the at least one vehicle, wherein the object related data includes at least one of condition of the at least one object present in the at least one vehicle, and presence of an unauthorized object in the at least one vehicle.

8. The security surveillance system of claim 2, wherein the at least one device is further configured to:
compare the identified at least one event with a pre-defined list of events; and
determine that the identified at least one event as the at least one unusual activity if the identified at least one event matches with an unusual activity present in the pre-defined list of events.

9. The security surveillance system of claim 2, wherein the generated at least one emergency alert is at least one of a push notification, a text based alert, a voice based alert, a visual based alert, and streaming of the at least one unusual activity detected in the at least one vehicle in a real-time.

10. The security surveillance system of claim 1, wherein the server is further configured to initiate the ride for the at least one user by:
receiving at least one initiate ride request and at least one criteria from the at least one commuter;
selecting a plurality of vehicles that meets the at least one criteria received from the at least one user;
forwarding the at least one initiate request to a plurality of drivers corresponding to the selected plurality of vehicles;
detecting a status of at least one of the at least one security device, and the at least one sensor present in the at least one vehicle on receiving a confirmation response from at least one driver corresponding to the at least one vehicle;
searching for at least one other vehicle from the plurality of vehicles for the at least one commuter if the detected status indicates at least one issue; and
transmitting confirmation details for initiating the ride to at least one of a driver corresponding to a vehicle of the at least one vehicle and the at least one commuter if the detected status indicates no issues in the vehicle.

11. A security device deployed in at least one vehicle comprising:
a memory; and
a Vision Processing Unit (VPU) coupled to the memory configured to detect at least one unusual activity by continuously monitoring at least one of an interior of the at least one vehicle and surrounding of the at least one vehicle.

12. The security device of claim 11, wherein the VPU is further configured to detect the at least one unusual activity using at least one of Artificial Intelligence and machine learning.

13. The security device of claim 12, wherein the VPU is further configured to:
collect data using at least one sensor placed in the at least one vehicle, wherein the collected data includes at least one of at least one media, vehicle data and additional information;
process the collected data to determine at least one of user related data, object related data, and a change in the vehicle data;
identify at least one event based on the determined at least one of the user related data, the object related data, and a change in the vehicle data; and
detect the identified at least one event as the at least one unusual activity by comparing the identified at least one event with a pre-defined list of events.

14. The security device of claim 13, wherein the user related data includes at least one of characteristics of the at least one user, the activities of the at least one user, emotions of the at least one user, and presence of at least one unauthorized user in the at least one vehicle, wherein the object related data includes at least one of condition of the at least one object present in the at least one vehicle, and presence of an unauthorized object in the at least one vehicle.

15. The security device of claim 13, wherein the VPU is further configured to communicate at least one of the collected data, the identified at least one event and the detected at least one unusual activity to at least one external device, wherein the detected at least one unusual activity is communicated as an emergency alert.

16. A method for real-time monitoring of at least one vehicle, the method comprising:
creating, by a security device placed in the at least one vehicle, a set of data related to the at least one vehicle and surrounding of the at least one vehicle on initiating a ride by at least one user, wherein the at least one user includes at least one of at least one driver and at least one commuter; and
communicating, by the security device, the created set of data to the server; and
performing, by a server, at least one action by analyzing the set of data communicated by the security device using at least one of Artificial Intelligence (AI) and machine learning.

17. The method of claim 16, wherein performing the at least one action includes at least one of:
communicating the set of data communicated by the security device to at least one external entity;
identifying at least one event based on the set of data communicated by the security device;
communicating the identified at least one event to the at least one external entity;
detecting at least one unusual activity based on the set of data communicated by the security device; and
generating and transmitting at least one emergency alert to the at least one external entity on detecting the at least one unusual activity.

18. The method of claim 16, wherein creating, by the security device, the set of data includes:
collecting at least one of at least one media related to the at least one vehicle, vehicle data and an additional information using at least one sensor placed in the at least one vehicle;
performing at least one correction procedure on the collected at least media to enhance quality of the collected at least one media; and
creating the set of data by appending the enhanced at least one media with at least one of the vehicle data and the additional information.

19. The method of claim 18, wherein the at least one media provides information about at least one of activities of the at least one user present inside the at least one vehicle, conditions of at least one object present in the at least one vehicle, a cockpit of the at least one vehicle, and surrounding environment of the at least one vehicle.

20. The method of claim 18, wherein the vehicle data includes at least one of vehicle speed, vehicle type, and vehicle location, wherein the additional information includes at least one of timestamps, date, and signal strength of the at least one communication network supported by the at least one security device.

21. The method of claim 17, wherein identifying the at least one event includes:
processing the created set of data using at least one of text summarization, properties of the at least one media, web detection, and object localizer to determine at least one of user related data, object related data, and a change in the vehicle data; and
identifying the at least one event based on the determined at least one of the user related data, the object related data and the change in the vehicle data.

22. The method of claim 21, wherein the user related data includes at least one of characteristics of the at least one user, the activities of the at least one user, emotions of the at least one user, and presence of at least one unauthorized user in the at least one vehicle, wherein the object related data includes at least one of condition of the at least one object present in the at least one vehicle, and presence of an unauthorized object in the at least one vehicle.

23. The method of claim 17, wherein detecting the at least one unusual activity includes:
comparing the identified at least one event with a pre-defined list of events; and
detecting that the identified at least one event as the at least one unusual activity if the identified at least one event matches with an unusual activity present in the pre-defined list of events.

24. The method of claim 17, wherein the generated at least one emergency alert is at least one of a push notification, a text based alert, a voice based alert, a visual based alert, and streaming of the at least one unusual activity detected in the at least one vehicle in a real-time.

25. The method of claim 16, the method comprising:
receiving, by the server, at least one initiate ride request and at least one criteria from the at least one commuter;
selecting, by the server, a plurality of vehicles that meets the at least one criteria received from the at least one user;
forwarding, by the server, the at least one initiate request to a plurality of drivers corresponding to the selected plurality of vehicles;
detecting, by the server, a status of at least one of the at least one security device, and the at least one sensor present in the at least one vehicle on receiving a confirmation response from the at least one driver corresponding to the at least one vehicle;
searching, by the server, for at least one other vehicle from the plurality of vehicles for the at least one commuter if the detected status indicates at least one issue; and
transmitting, by the server, confirmation details for initiating the ride to at least one of a driver corresponding to a vehicle of the at least one vehicle and the at least one commuter if the detected status indicates no issues in the vehicle.
